(19) United States
(12) Patent Application Publication
(10) Pub. No.: US 2024/0105184 A1
(43) Pub. Date: Mar. 28, 2024

(54) NON-TRANSITORY COMPUTER READABLE MEDIUM AND WEB CONFERENCING SYSTEM

(71) Applicant: FUJIFILM BUSINESS INNOVATION CORP., Tokyo (JP)

(72) Inventor: Hidetomo NAKAYAMA, Kanagawa (JP)

(73) Assignee: FUJIFILM BUSINESS INNOVATION CORP., Tokyo (JP)

(21) Appl. No.: 18/159,851

(22) Filed: Jan. 26, 2023

(30) Foreign Application Priority Data
Sep. 27, 2022 (JP) 2022-153503

(51) Int. Cl. G10L 17/06; G06F 3/04847; G06F 3/16; G06V 40/16; G06V 40/20; H04L 65/403

(52) U.S. Cl. CPC G10L 17/06; G06F 3/04847; G06F 3/165; G06V 40/176; G06V 40/20; H04L 65/403

(57) ABSTRACT

A non-transitory computer readable medium is provided, the medium storing a program causing a process to be executed by a computer operating as a server of a web conferencing system, the process including: identifying a group of participants sharing a microphone to be used for voice input; and identifying, if information indicating a volume equal to or greater than a reference value from a terminal not connected to the microphone from among terminals of the participants belonging to the group is inputted while a voice from the group is being inputted, the participant whose terminal corresponds to the transmission origin of the information as a speaking person.

### CROSS-REFERENCE TO RELATED APPLICATIONS

This application is based on and claims priority under 35 USC 119 from Japanese Patent Application No. 2022-153503 filed Sep. 27, 2022.

### BACKGROUND

### (i) Technical Field

The present disclosure relates to a non-transitory computer readable medium and a web conferencing system.

### (ii) Related Art

As remote work and the like is becoming more widespread, the demand for web conferencing is increasing. Web conferencing is achieved by connecting the terminals of participants to the Internet. Incidentally, there are a variety of ways in which a web conference may be convened, and it is not necessarily the case that all participants are located in different places. For example, among four participants A, B, C, and D, the participant A may participate from home while the participants B, C, and D may gather together and participate from a conference room. In this case, the web conference is convened in two places. See, for example, Japanese Unexamined Patent Application Publication No. 2017-168903.

### SUMMARY

A speakerphone may be used in cases where multiple people participate in a web conference from the same place. A speakerphone is a device that integrates a speaker and a microphone, and is effective in reducing howling and voice interruptions. On the other hand, if a speakerphone is used, all of the voices inputted from the speakerphone are linked with the terminal connected to which the speakerphone. For example, an utterance by the participant D is treated as an utterance by the participant B corresponding to the terminal connected to the speakerphone.

Aspects of non-limiting embodiments of the present disclosure relate to enabling the actual speaking person to be identified, even in a situation where some of the participants in a web conference share a single microphone. Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a non-transitory computer readable medium storing a program causing a process to be executed by a computer operating as a server of a web conferencing system, the process including: identifying a group of participants sharing a microphone to be used for voice input; and identifying, if information indicating a volume equal to or greater than a reference value from a terminal not connected to the microphone from among terminals of the participants belonging to the group is inputted while a voice from the group is being inputted, the participant whose terminal corresponds to the transmission origin of the information as a speaking person.

### BRIEF DESCRIPTION OF THE DRAWINGS

Exemplary embodiments of the present disclosure will be described in detail based on the following figures, wherein:

FIG. 1 is a diagram illustrating an exemplary configuration of a web conferencing system;

FIG. 2 is a diagram illustrating an example of a hardware configuration of a server;

FIG. 3 is a diagram illustrating an example of a functional configuration achieved by a processor;

FIG. 4 is a diagram for explaining an example of a data structure of a participant table storing information about users who have entered a web conference room;

FIG. 5 is a diagram for explaining an example of a data structure of a dialogue history table;

FIG. 6 is a diagram for explaining an example of a dialogue history created for a web conference;

FIG. 7 is a diagram illustrating an example of a hardware configuration of a user terminal;

FIG. 8 is a diagram illustrating an example of a functional configuration achieved by a processor;

FIG. 9 is a diagram for explaining differences between a voice input mode and a volume input mode;

FIG. 10 is a diagram illustrating an example of a hardware configuration of a speakerphone;

FIG. 11 is a sequence diagram for explaining a speaking person identification process performed through the cooperation of a server and user terminals;

FIG. 12 is a diagram for explaining an example of a settings screen;

FIG. 13 is a diagram for explaining a settings screen for persons B, C, and D who gather together in a conference room to participate in a web conference;

FIG. 14 is a diagram for explaining an exemplary display of a shared screen at the stage of accepting participants;

FIG. 15 is a diagram for explaining a case where person A not belonging to a group speaks;

FIG. 16 is a diagram for explaining a case where person B belonging to a group speaks;

FIG. 17 is a diagram for explaining a case where person C belonging to a group speaks;

FIG. 18 is a diagram for explaining a case where persons C and D belonging to a group speak at the same time;

FIG. 19 is a diagram for explaining one portion of other processing operations executed by a server;

FIG. 20 is a diagram for explaining a remaining portion of other processing operations executed by a server;

FIG. 21 is a diagram for explaining another example of a case where person C belonging to a group speaks;

FIG. 22 is a diagram for explaining another example of a case where persons C and D belonging to a group speak at the same time;

FIG. 23 is a diagram for explaining an example in which person C belonging to a group speaks, but voice information pertaining to person C is not received by a server;

FIG. 24 is a diagram for explaining an example of other processing operations executed by a server;

FIG. 25 is a diagram for explaining an example of identifying a speaking person from between two users who do not belong to the same group;

FIG. 26 is a diagram for explaining an example of a settings screen;

FIG. 27 is a diagram for explaining an exemplary screen used to accept a form of participation in a web conference;

FIG. 28 is a flowchart for explaining an example of remote control by a server in a case where a user operation is accepted on a reception screen;

FIG. 29 is a diagram for explaining an exemplary display of a form of participation; and

FIG. 30 is a diagram for explaining an exemplary display of a shared screen in a case where the participants in a web conference are included in multiple groups.

### DETAILED DESCRIPTION

Hereinafter, exemplary embodiments of the present disclosure will be described with reference to the drawings.

<System configuration>

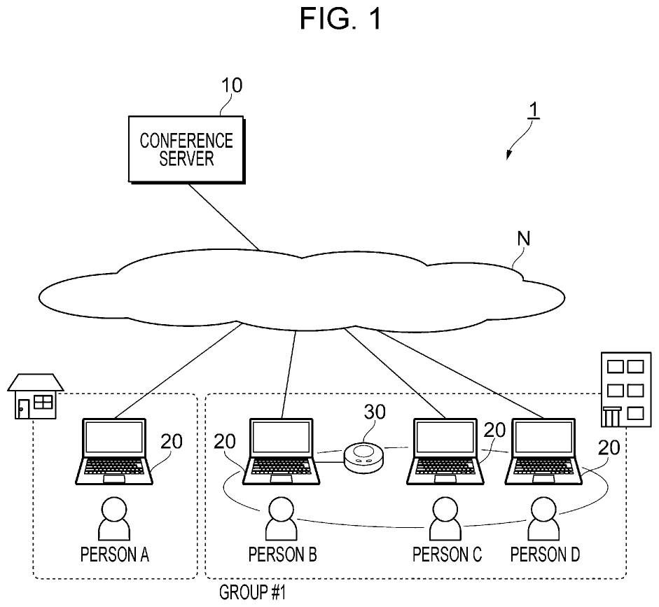

FIG. 1 is a diagram illustrating an exemplary configuration of a web conferencing system 1. The web conferencing system 1 illustrated in FIG. 1 includes a conference server (hereinafter referred to as the “server”) 10 that provides a web conferencing service, user terminals 20 linked with each of the users who participate in a web conference, a speakerphone 30 shared by multiple users, and a network N connecting the above.

A “web conference” refers to a conference achieved through communication on a network. Streaming technology is used to distribute video, audio, and other data to participants. Participation in the web conference is granted only to specific users who have received an invitation email or have been authenticated in advance. “Sharing” means that multiple people jointly use a single piece of equipment. In the present exemplary embodiment, the speakerphone 30 is assumed as the shared equipment.

Four people, namely “person A”, “person B”, “person C”, and “person D” participate in the web conference illustrated in FIG. 1. Needless to say, the number of participants and the like is an example. In the case of FIG. 1, “person A” participates in the web conference alone from their home or the like. The three people “person B”, “person C”, and “person D” gather together and participate in the web conference from a conference room of a company or the like. In FIG. 1, the gathering of “person B”, “person C”, and “person D” sharing the speakerphone 30 is designated Group #1.

In the case of FIG. 1, the voices of “person B”, “person C”, and “person D” are picked up by the speakerphone 30 and distributed to the user terminal 20 of “person A” via the user terminal 20 of “person B” connected to the speakerphone 30 and the server 10. On the other hand, the voice of “person A” is picked up by a microphone provided in the user terminal 20 of “person A” and distributed to the speakerphone 30 via the server 10. Note that in a broad sense, “person A” may be thought of as a group containing a single person. However, “person A” and the microphone correspond 1:1, and the single microphone is not shared with another user. For this reason, in the present exemplary embodiment, the term “group” is used to distinguish between the case where a microphone is shared by multiple people and the case where a microphone is used exclusively by a single person.

FIG. 1 illustrates a case where the space inhabited by “person A” and the space inhabited by “person B”, “person C”, and “person D” are physically different, but all four of “person A”, “person B”, “person C”, and “person D” may also be present in the same space. In this case, “person A”, “person B”, “person C”, and “person D” may also be present in the same space insofar as only the voice of “person A” is picked up by the microphone for “person A”, and the voices of “person B”, “person C”, and “person D” are picked up by the speakerphone 30. The network N is assumed to be the Internet and/or a local area network (LAN). A portion of the network N may also be a mobile communication system such as 5G. Needless to say, the network N may be a wired network or a wireless network.

<Configuration of Each Terminal>

### <Configuration of Server>

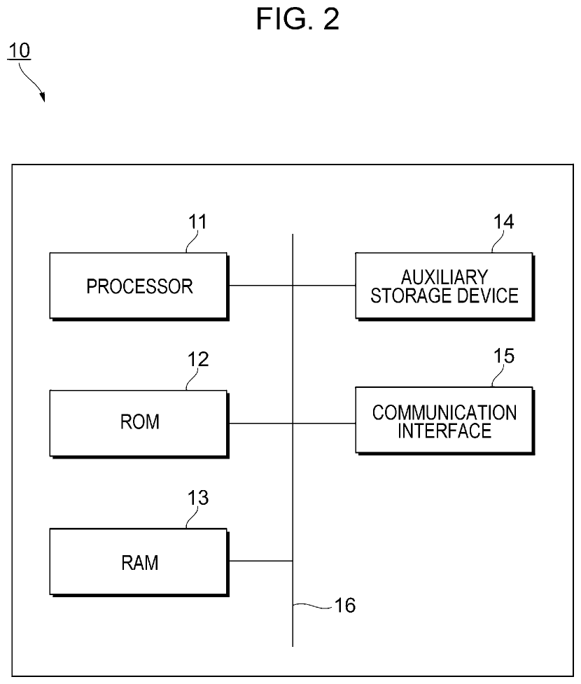

FIG. 2 is a diagram illustrating an example of a hardware configuration of the server 10. The server 10 is a terminal connected to the user terminals 20 (see FIG. 1) used by the participants of the web conference, performing setup and establishing communication relevant to achieving the web conference. The server 10 may be an on-premises server or a cloud server. The server 10 illustrated in FIG. 2 includes a processor 11, read-only memory (ROM) 12 storing data such as a basic input-output system (BIOS), random access memory (RAM) 13 that is used as a work area of the processor 11, an auxiliary storage device 14, and a communication interface 15. Each device is connected through a bus or other signal line 16.

The processor 11 is a device that achieves various functions by executing a program. The processor 11, ROM 12, and RAM 13 function as a computer. The auxiliary storage device 14 includes a hard disk drive and/or semiconductor storage, for example. A program and various data are stored in the auxiliary storage device 14. Here, “program” is used as a collective term for an operating system (OS) and application programs. One of the application programs is a program related to web conferencing. In the present exemplary embodiment, the auxiliary storage device 14 is built into the server 10, but may also be externally attached to the server 10 or may exist on the network N (see FIG. 1).

The communication interface 15 is an interface for communicating with the user terminals 20 (see FIG. 1) through the network N. The communication interface 15 supports any of various types of communication standards. Here, the communication standards may be Ethernet (registered trademark), Wi-Fi (registered trademark), and/or a mobile communication system, for example.

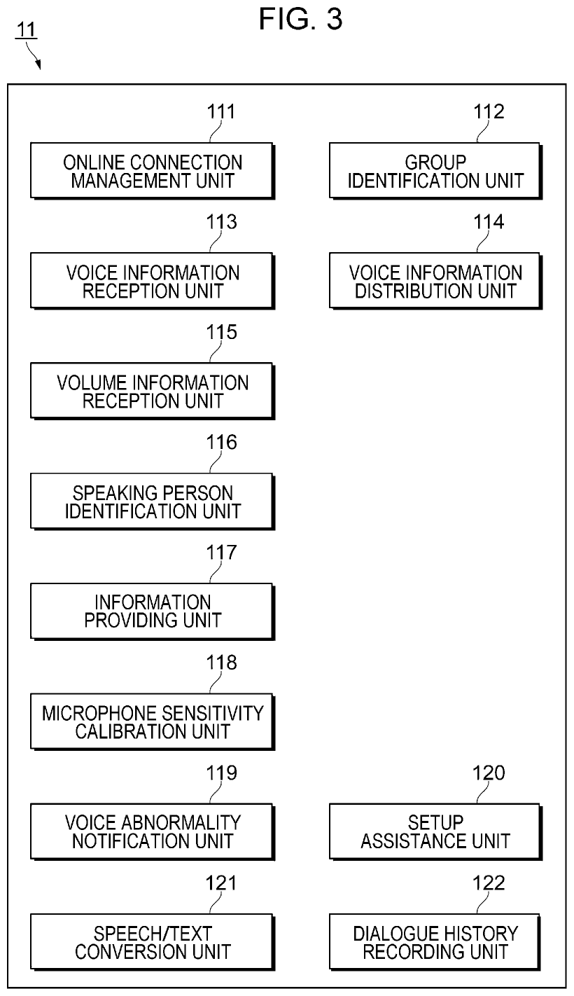

FIG. 3 is a diagram illustrating an example of a functional configuration achieved by the processor 11. The function units illustrated in FIG. 3 are achieved through the execution of a program by the processor 11. The function units illustrated in FIG. 3 are an online connection management unit 111, a group identification unit 112, a voice information reception unit 113, a voice information distribution unit 114, a volume information reception unit 115, a speaking person identification unit 116, an information providing unit 117, a microphone sensitivity calibration unit 118, a voice abnormality notification unit 119, a setup assistance unit 120, a speech/text conversion unit 121, and a dialogue history recording unit 122.

The online connection management unit 111 is a function unit that manages connections with users who participate in the web conference. For example, if a connection to a Uniform Resource Locator (URL) prepared for the web conference is accepted, the online connection management unit 111 records the “entry” of the user corresponding to the user terminal 20 from which the connection originates. Also, if a disconnection is detected, the online connection management unit 111 records the “exit” of the user corresponding to the user terminal 20. Here, “entry” and “exit” are stored in the auxiliary storage device 14 (see FIG. 2), for example. On a screen for initiating participation in the web conference, the setting of a mode for transmitting “volume information” described later is also received.

Note that a button for setting the mode for transmitting “volume information” may also be displayed only in the case where a mode for transmitting “voice information” described later is set to OFF. This is because if at least “voice information” is set, it is possible to identify the speaking person even if “volume information” is not transmitted. Also, if the mode for transmitting “voice information” is set to ON, the button for setting the mode for transmitting “volume information” may also be displayed in a non-operable state. Also, the button for setting the mode for transmitting “volume information” may be displayed on the screen only in the case where a mode for sharing the speakerphone 30 with other users has been selected.

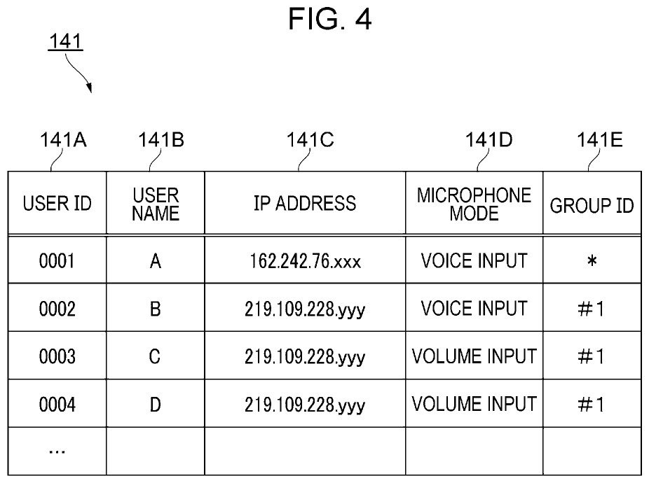

The group identification unit 112 is a function unit that identifies a group of users sharing the speakerphone 30 (see FIG. 1). The group identification unit 112 identifies the group to which a user belongs by referencing the IP address or the like of the user terminal 20 corresponding to the user who has entered. The IP address or the like is recorded in a participant table 141 (see FIG. 4). FIG. 4 is a diagram for explaining an example of a data structure of the participant table 141 storing information about users who have entered a web conference room. The participant table 141 is prepared for each web conference. The participant table 141 includes fields for a user ID 141A, a user name 141B, IP address 141C, a microphone mode 141D, a group ID 141E, and the like.

The user ID 141A is used to identify the users A, B, C, and D who participate in the web conference. The user name 141B is used for presentation to the users who participate in the web conference. The user name 141B is registered by each user when an online connection is established. The IP address 141C is the IP address of the user terminal 20 connected to the server 10. The IP address in this case is assumed to be a global IP address. However, in the case where the web conferencing system 1 is set up on the same LAN, a private IP address is registered. The IP address is an example of information expressing a location on a network.

The microphone mode 141D is an operating mode of the microphone for the user terminal 20 to be used in the web conference. Although details will be described later, the operating modes include a “voice input” mode for uploading a voice picked up by the microphone and a “volume input” mode for uploading the level of sound (that is, the volume) picked up by the microphone. For example, the group identification unit 112 (see FIG. 3) links the user of a user terminal 20 (see FIG. 1) set to the “volume input” mode to a group. In other words, the group identification unit 112 links the user of a user terminal 20 set to the “volume input” mode to the user of a user terminal 20 set to the “voice input” mode.

In the group ID 141E, the result of identification by the group identification unit 112 (see FIG. 2) is recorded. In the case of the present exemplary embodiment, users with a common global IP address are identified as belonging to the same group. In FIG. 4, Group #1 is recorded with respect to the three people having the user ID 141A from “0002” to “0004”. Note that in the case where the IP address is a private IP address, the participants belonging to a group may be identified on the basis of input by participants in response to a screen for declaration or query. In the case of the present exemplary embodiment, a group includes a single user terminal 20 operating in the voice input mode and one or multiple user terminals 20 operating in the volume input mode.

The description will now return to FIG. 3. The voice information reception unit 113 is a function unit that receives voice information from the user terminal 20 set to the “voice input” mode. In the present exemplary embodiment, the voice information is assumed to be encoded data of sound picked up by a microphone built into the user terminal 20 or by the speakerphone 30, for example. Note that encoded data associated with the same speaking person is recorded in the auxiliary storage device 14 (see FIG. 2) as one or more audio files. The voice information distribution unit 114 is a function unit that distributes received voice information to users other than the originating user. The voice information distribution unit 114 treats the user terminal 20 operating in the “voice input” mode as a distribution destination. The volume information reception unit 115 is a function unit that receives volume information from the user terminal 20 set to the “volume input” mode. In the present exemplary embodiment, the volume information is assumed to be a numerical value expressing the level of sound (that is, the volume), for example.

The speaking person identification unit 116 is a function unit that identifies the user who speaks (that is, the speaking person) in a web conference. For example, if voice information is received from the user terminal 20 not belonging to a group, the speaking person identification unit 116 identifies the corresponding user as the speaking person. In the example of FIG. 1, if voice information is received from the user terminal 20 corresponding to “person A”, “person A” is identified as the speaking person. Also, if volume information equal to or greater than a reference value is received from a user terminal 20 not connected to the speakerphone 30 while voice information is being inputted from a user terminal 20 belonging to a group, the speaking person identification unit 116 identifies the user of the user terminal 20 corresponding to the transmission origin of the volume information as the speaking person. In the example of FIG. 1, if volume information is received from the user terminal 20 corresponding to “person C”, “person C” is identified as the speaking person.

Note that if volume information is received from a user terminal 20 belonging to the same group while voice information is being inputted from the group, the speaking person identification unit 116 identifies the user corresponding to the user terminal 20 that transmitted the loudest volume information as the speaking person. For example, if the volume information for “person C” is level 4 and the volume information for “person D” is level 2, the speaking person identification unit 116 identifies “person C” as the speaking person. Also, if volume information equal to or greater than the reference value is not inputted from a user terminal 20 belonging to the same group while voice information is being inputted from the group, the speaking person identification unit 116 identifies the user linked to the user terminal 20 that transmitted the voice information as the speaking person. In the example of FIG. 1, if voice information is received from the user terminal 20 corresponding to “person B”, and volume information is not being received from the user terminal 20 corresponding to “person C” and the like, “person B” is identified as the speaking person.

Otherwise, the speaking person identification unit 116 may also have a function for inferring the speaking person through analysis of a captured image of a user. The inference of the speaking person at this time may be executed when an image captured by the user terminal 20 in question is available for use. In the analysis of the image, the probability of utterance is inferred on the basis of the user's expression, for example. The expression includes not only the movement of the mouth, but also gestures and overall facial movements.

Note that the identification of the speaking person by the above function may be limited to cases where the user has set the camera to ON from a settings screen of the user terminal 20. However, the identification of the speaking person by the above function may also be executed in cases where the user has set the camera to OFF from the settings screen of the user terminal 20. In this case, the image of the user in question is not shared with the other users participating in the web conference, but the image does reach the server 10, and thus identification of the speaking person through image analysis is achieved. However, enabling this identification of the speaking person may be conditional on consent from the users participating in the web conference.

The information providing unit 117 is a function unit that provides various information related to the web conference to the user terminal 20 used by each user participating in the web conference. The provision of information is achieved through a screen (hereinafter referred to as the “shared screen”) displayed on each user terminal 20. Note that the shared screen is distributed by being streamed. One type of information to be provided is information about the users participating in the web conference. By providing this type of information, each user joining the web conference is able to gain information about the other users who have joined. Note that information providing unit 117 displays information about a user belonging to a group with a different appearance from another user not belonging to the group. For example, a user belonging to the group is denoted with a mark or symbol, whereas another user not belonging to the group is not denoted with a mark or the like. As another example, users belonging to the group are displayed enclosed inside a frame. Obviously, a user not belonging to the group is displayed on the outside of the frame.

Also, if the web conference includes multiple groups, the information providing unit 117 displays differences between the groups on the shared screen. This function enables each user to easily understand the form of participation by the other users. Also, in the case where the user identified as the speaking person belongs to a group, the information providing unit 117 displays the user with a different appearance than the case where the user identified as the speaking person does not belong to a group. For example, one or more of a symbol, brightness, color, type of frame, thickness, or shape indicating the speaking person is changed. However, it is also possible to adopt the same display appearance for the case of belonging to a group and the case of not belonging to a group.

The microphone sensitivity calibration unit 118 is a function unit that makes the microphone sensitivity uniform among the user terminals 20 of users belonging to the same group. As described above, if multiple pieces of volume information are received from user terminals 20 belonging to the same group, the speaking person identification unit 116 identifies the user corresponding to the user terminal 20 that transmitted the loudest volume information as the speaking person. For this reason, if the microphone sensitivity differs among the user terminals 20, there is a possibility that the speaking person identification unit 116 may misidentify the speaking person. For example, in the case of a microphone with low sensitivity, the numerical value of the volume information will be less than the actual volume, even if the user speaks loudly. On the other hand, in the case of a microphone with high sensitivity, the numerical value of the volume information will be greater than the actual volume, even if the user speaks quietly. As a result, there is a possibility that the user speaking quietly may be identified as the speaking person rather than the user speaking loudly.

Accordingly, before the web conference starts or during the initial stage of the web conference, for example, the microphone sensitivity calibration unit 118 collects information related to microphone selection and a sensitivity setting from each user terminal 20, and calibrates the volume information to be transmitted. For example, if different types of microphones are selected by multiple user terminals set to the volume input mode from among the user terminals 20 belonging to the same group, the microphone sensitivity calibration unit 118 instructs the user terminals 20 in question to select the same microphone. Additionally, if the microphone sensitivity settings are different, the microphone sensitivity calibration unit 118 instructs the user terminals 20 in question to set the same sensitivity.

The voice abnormality notification unit 119 is a function unit that notifies the user terminal 20 of an abnormality detected on the basis of the voice information or the volume information. For example, if the reception or input of volume information from the user terminal of a user belonging to a group is detected, but the reception or input of voice information from the same group is not detected, a notification indicating that a voice is not detected is issued to the users belonging to the group. However, the recipient of the notification may also be only the user with a high probability of being the speaking person.

A notification may be issued if the speakerphone 30 is powered off, if there is communication trouble between the speakerphone 30 and a user terminal 20 in the voice input mode, or if a user participating in the volume input mode is too far from the speakerphone 30 and the user's voice is not being picked up, for example. Note that communication trouble encompasses a missing cable connection, a cable disconnection, poor pairing, and the like. Note that in the case where the speaking person is identified through the analysis of an image captured by a camera built into or connected to a user terminal 20, if volume information is not received or inputted from the user terminal 20 corresponding to the speaking person, the voice abnormality notification unit 119 may issue a notification to the user in question, the notification indicating the possibility of a malfunction or failure of a microphone built into or connected to the user terminal 20.

The setup assistance unit 120 is a function unit that transmits an instruction for setting the voice input mode to OFF and an instruction for setting the volume input mode to ON to user terminals 20 other than the user terminal 20 with the voice input mode set to ON among the user terminals 20 corresponding to the users belonging to a group. This arrangement makes it possible to apply the correct settings, even if a user not connected to the speakerphone 30 has mistakenly set the voice input mode to ON. Accordingly, howling may be avoided before it occurs. The speech/text conversion unit 121 is a function unit that converts speech included in an audio file into text. In the case of the present exemplary embodiment, speech/text conversion is executed by the server 10, but the server 10 may also achieve conversion into text by coordinating with another server.

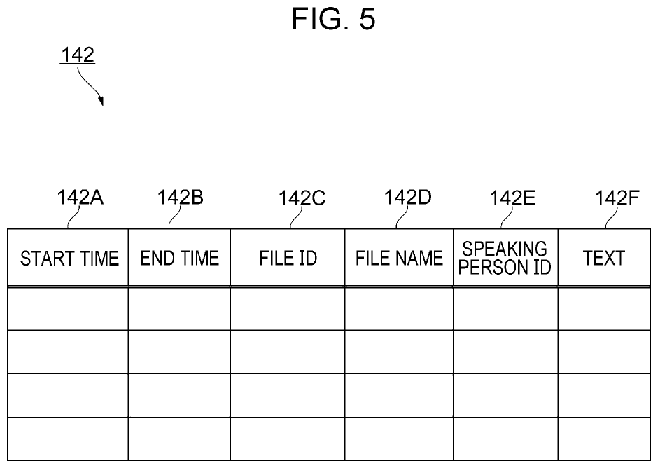

The dialogue history recording unit 122 is a function unit that records information about the user corresponding to a user terminal 20 in association with a voice. This is, in other words, a function for creating conference minutes. FIG. 5 is a diagram for explaining an example of a data structure of a dialogue history table 142. The dialogue history table 142 is recorded for each web conference. The dialogue history table 142 includes fields for a start time 142A, an end time 142B, a file ID 142C, a file name 142D, a speaking person ID 142E, text 142F, and the like. The start time 142A is the time at which voice information started being received. The time of receiving voice information is recorded even if the speaking person is not identified. The end time 142B is the time at which voice information stopped being received.

The file ID 142C is information for identifying an audio file. The file ID 142C makes it is possible to link to an audio file recorded in the auxiliary storage device 14 (see FIG. 2). The file name 142D is the file name of the audio file linked to the file ID 142C. The speaking person ID 142E is an ID of the user identified as the speaking person. Note that the name of the user identified as the speaking person may also be recorded. The text 142F is a character string converted from the audio file.

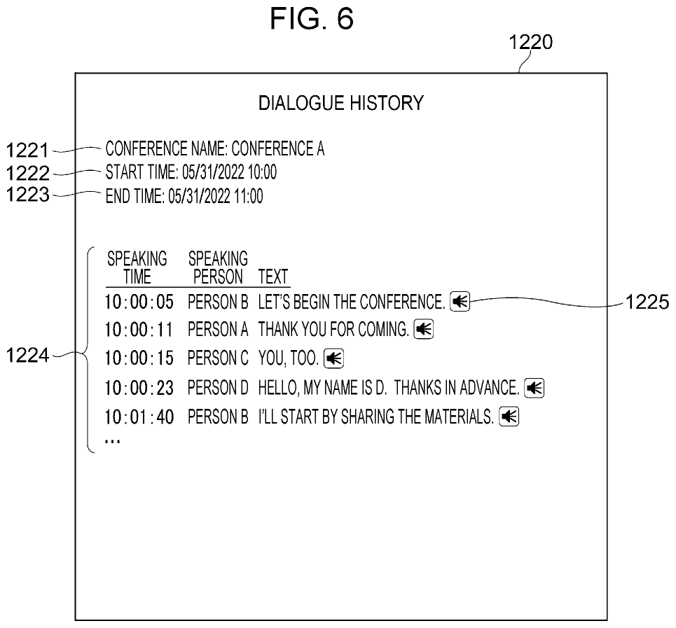

FIG. 6 is a diagram for explaining an example of a dialogue history 1220 created for a web conference. Note that the dialogue history 1220 illustrated in FIG. 6 is assumed to be viewed on a user terminal 20 (see FIG. 1). The dialogue history 1220 includes a conference name 1221, a start date and time 1222, an end date and time 1223, utterance content 1224, and playback buttons 1225. In the case of FIG. 6, the conference name 1221 is “Conference A”. Also, the start date and time 1222 and the end date and time 1223 record that Conference A was held from 10:00 to 11:00 on May 31, 2022. Also, the utterance content 1224 records a timeline of speaking persons and text content. Note that the playback buttons 1225 are arranged to allow for the playback of audio files. If one of the playback buttons 1225 is operated, the corresponding audio file is played.

<Configuration of User Terminal>

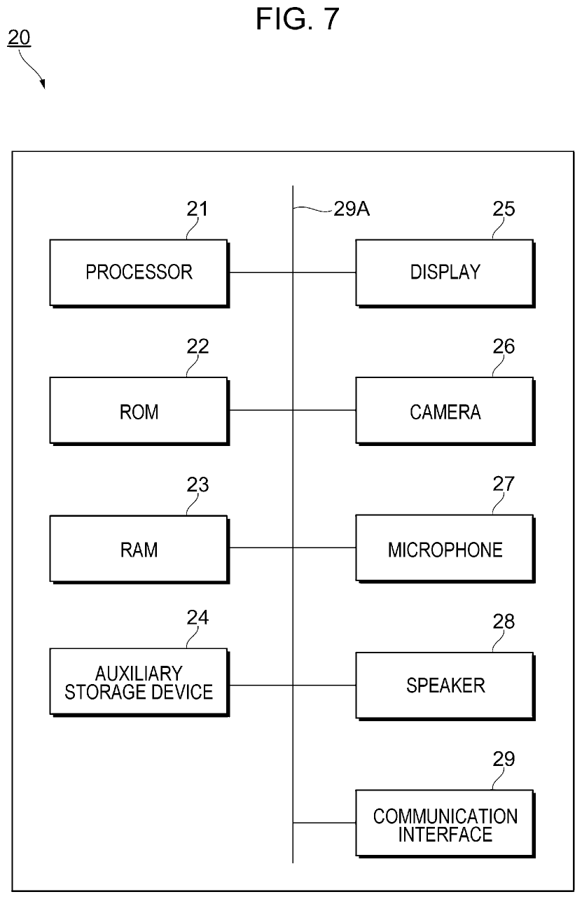

FIG. 7 is a diagram illustrating an example of a hardware configuration of the user terminal 20. The user terminal 20 illustrated in FIG. 7 includes a processor 21, ROM 22 storing a BIOS and the like, RAM 23 used as a work area of the processor 21, an auxiliary storage device 24, a display 25, a camera 26, a microphone 27, a speaker 28, and a communication interface 29. Each device is connected through a bus or other signal line 29A.

The processor 21 is a device that achieves various functions by executing a program. The processor 21, ROM 22, and RAM 23 function as a computer. The auxiliary storage device 24 includes a hard disk drive and/or semiconductor storage, for example. A program and various data are stored in the auxiliary storage device 24. The program encompasses an OS and application programs. One of the application programs is a program related to web conferencing. The display 25 is a liquid crystal display (LCD) or an organic electroluminescent (OLED) display, for example.

The camera 26 is placed near or attached to the display 25, for example. In the case of the present exemplary embodiment, the camera 26 is used to capture an image of the user. The microphone 27 is an acoustic device that converts sound into the form of an electrical signal. The speaker 28 is an acoustic device that converts an electrical signal expressing sound into sound. The communication interface 29 is an interface for communicating with the server 10 (see FIG. 1) through the network N. The communication interface 29 supports any of various types of communication standards.

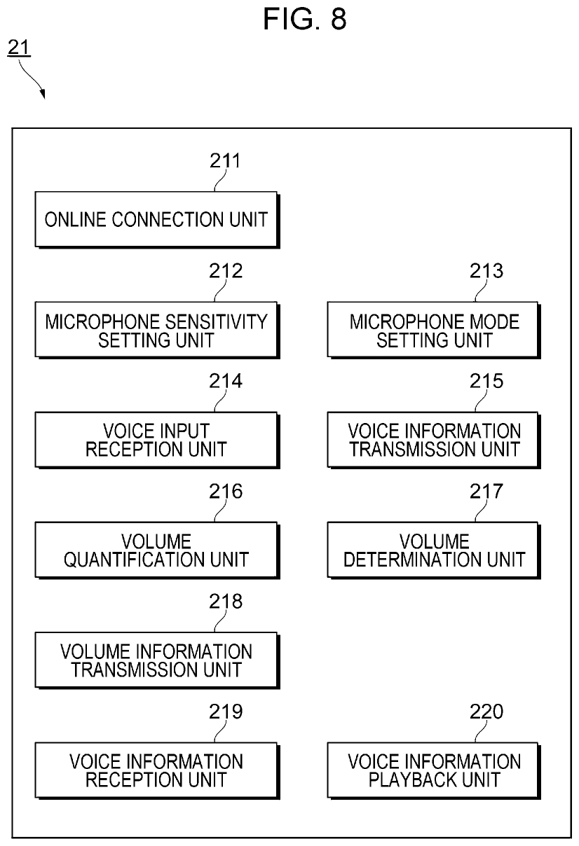

FIG. 8 is a diagram illustrating an example of a functional configuration achieved by the processor 21. The function units illustrated in FIG. 8 are achieved through the execution of a program by the processor 21 (see FIG. 7). The function units illustrated in FIG. 8 are an online connection unit 211, a microphone sensitivity setting unit 212, a microphone mode setting unit 213, a voice input reception unit 214, a voice information transmission unit 215, a volume quantification unit 216, a volume determination unit 217, a volume information transmission unit 218, a voice information reception unit 219, and a voice information playback unit 220.

The online connection unit 211 is a function unit that executes a process of connecting to a URL issued for the web conference. Besides being acquired through email, a short messaging service, or the like, the URL is also acquirable by selecting a conference room displayed on a browser screen. The microphone sensitivity setting unit 212 is a function unit that sets the maximum amplitude of an electrical signal to be outputted from the microphone 27 (see FIG. 7), on the basis of an operation by the user or an instruction from the server 10 (see FIG. 1). The microphone mode setting unit 213 is a function unit that determines how the electrical signal outputted from the microphone 27 is to be handled. In other words, the microphone mode setting unit 213 is a function unit that sets the operating mode of the user terminal 20.

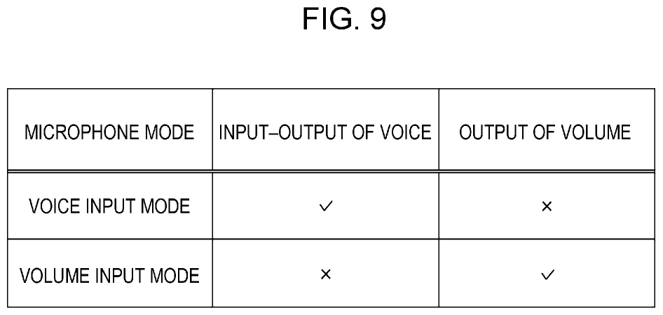

In the case of the present exemplary embodiment, there are two types of microphone modes: a “voice input” mode and a “volume input” mode. FIG. 9 is a diagram for explaining the differences between the “voice input” mode and the “volume input” mode. In the “voice input” mode, the user terminal 20 is allowed to input and output voice, but is not allowed to output volume. Here, being allowed to input and output voice means that sound picked up by the microphone 27 or the speakerphone 30 (see FIG. 1) is uploaded as voice information X to the server 10, and voice information X received from the server 10 is outputted as sound from the speaker 28 (see FIG. 7) or the speakerphone 30.

In the “volume input” mode, the user terminal 20 is allowed to output volume, but is not allowed to input and output voice. Here, being allowed to output volume means that the volume of sound picked up by the microphone 27 is uploaded as volume information Y to the server 10. Note that the microphone mode may be set according to a method of adjusting the microphone volume on an operation screen displayed on the display 25 or a method of operating a mode selection button. For example, if the microphone volume is set to “0”, the “volume input” mode may be set. Note that a selection button for the “volume input” mode may be configured to be displayed on the screen if the microphone volume is set to “0”.

The voice input reception unit 214 is a function unit that receives an electrical signal corresponding to sound picked up by the microphone 27. The voice information transmission unit 215 is a function unit that uploads encoded data, which is obtained by encoding an electrical signal inputted from the microphone 27, as voice information X to the server 10. The volume quantification unit 216 is a function unit that quantifies the loudness of sound picked up by the microphone 27. The volume determination unit 217 is a function unit that compares the numerical value of sound to a reference value REF. In the case of the present exemplary embodiment, the comparison to the reference value REF is used to distinguish between an utterance by the user operating the terminal itself and ambient sound. Ambient sound encompasses the voices of other users corresponding to other user terminals 20 and nearby sound.

The volume information transmission unit 218 is a function unit that, in a case where sound of a loudness equal to or greater than the reference value REF is detected, uploads volume information Y expressing an utterance by the corresponding user to the server 10. The voice information reception unit 219 is a function unit that receives voice information X from the server 10. The voice information playback unit 220 is a function unit that causes voice information X received from the server 10 to be played back from the speaker 28 or the speakerphone 30.

<Configuration Speakerphone>

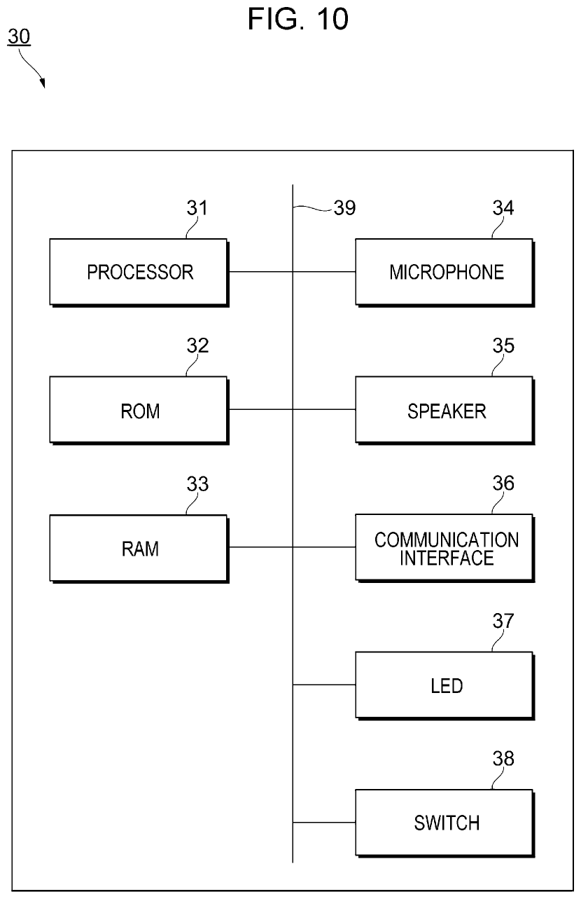

FIG. 10 is a diagram illustrating an example of a hardware configuration of the speakerphone 30. The speakerphone 30 illustrated in FIG. 10 includes a processor 31, ROM 32 storing a BIOS, firmware, and the like, RAM 33 used as a work area of the processor 31, a microphone 34, a speaker 35, a communication interface 36, a light-emitting diode (LED) 37, and a switch 38. Each device is connected through a bus or other signal line 39.

The processor 31 is a device that encodes sound, decodes voice information, and the like by executing a program such as firmware. Note that the encoding of sound and the decoding of voice information X may also be achieved by an application-specific integrated circuit (ASIC). The processor 31, ROM 32, and RAM 33 function as a computer. The microphone 34 is an acoustic device that converts sound into the form of an electrical signal. The speaker 35 is an acoustic device that converts an electrical signal expressing sound into sound. The communication interface 36 is an interface for communicating with a connected user terminal 20 (see FIG. 1). The communication interface 36 supports any of various types of communication standards. The LED 37 is a light-emitting element that notifies the user of the status of operation. The switch 38 is a switch for turning the power on or off, for instance.

<Speaking Person Identification Process>

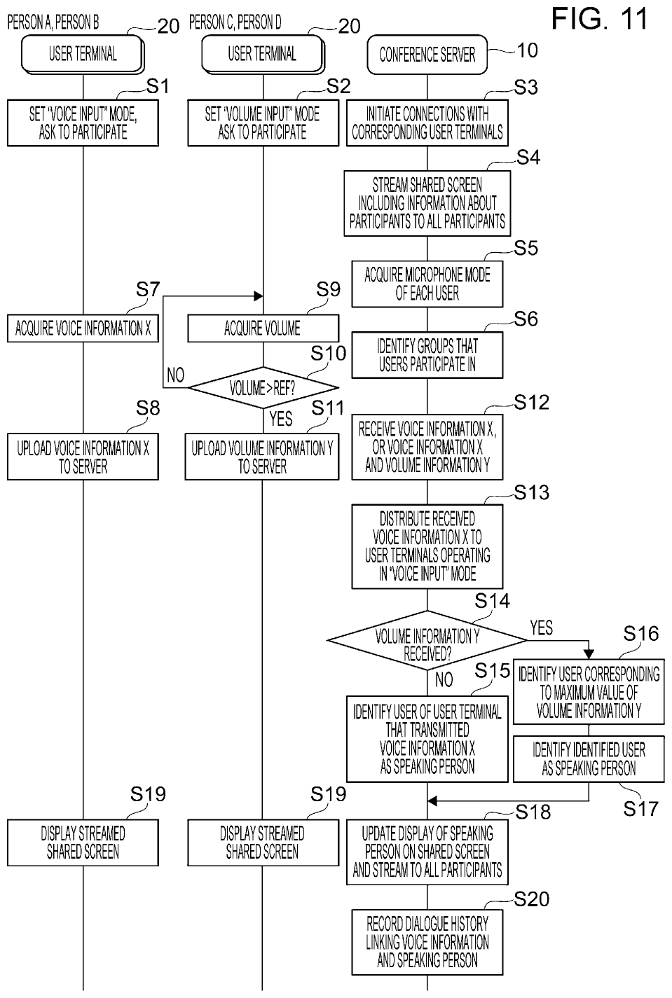

FIG. 11 is a sequence diagram for explaining a speaking person identification process performed through the cooperation of the server 10 and the user terminals 20. Note that the sequence diagram illustrated in FIG. 11 is an example of processing operations. Also, the symbol “S” in FIG. 11 means “step”. Herein, the participants in the web conference are likewise taken to be the four persons A, B, C, and D. Moreover, the form of participation by each participant is the same as illustrated in FIG. 1. Note that persons A, B, C, and D are referred to as the “user(s)” when not being distinguished individually.

In other words, person A participates from home or the like, while persons B, C, and D gather together and participate from a conference room of a company or the like. Also, persons B, C, and D use the speakerphone 30 (see FIG. 1) to participate in the conference. Note that the speakerphone 30 (see FIG. 1) is connected to the user terminal 20 of person B. Note that due to space limitations, in FIG. 11, the user terminal 20 of person A and the user terminal 20 of person B are associated with the same time axis, while the user terminal 20 of person C and the user terminal 20 of person D are associated with the same time axis.

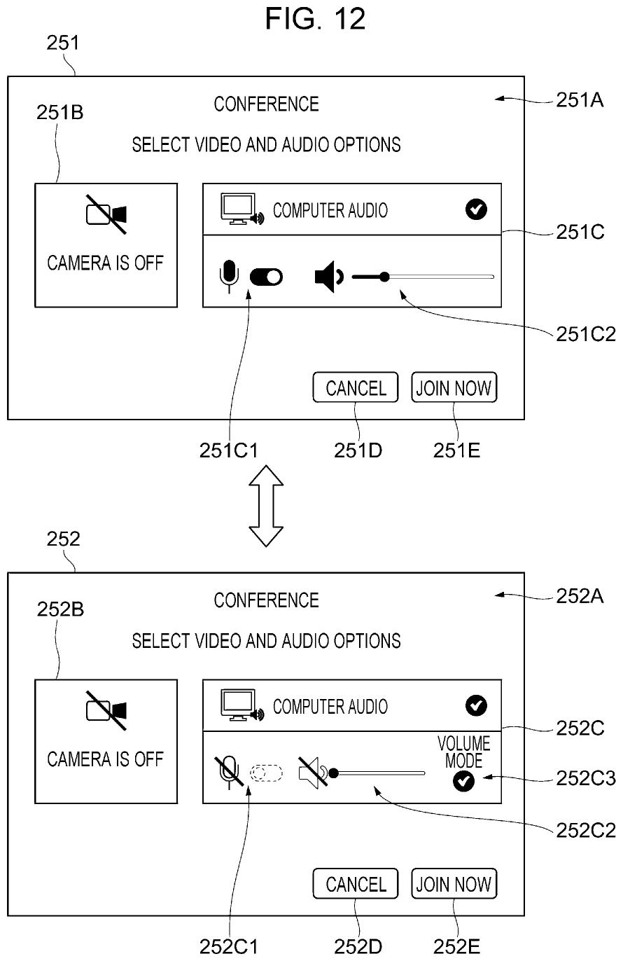

First, after setting up the camera and microphone, each user accesses the URL of the web conference managed by the server 10. FIG. 12 is a diagram for explaining an example of a settings screen. FIG. 12 illustrates two settings screens 251 and 252 in which the microphone 27 (see FIG. 7) is set up differently. The settings screen 251 is an example of a screen in which the microphone 27 is set to ON, and the settings screen 252 is an example of a screen in which the microphone 27 is set to OFF. The settings screen 251 corresponds to the “voice input” mode described above, and the settings screen 252 corresponds to the “volume input” mode.

Explanations 251A and 252A are placed in the upper portion of the settings screens 251 and 252. In the case of FIG. 12, “Select video and audio options” is displayed on both screens. In camera setting fields 251B and 252B, it is possible to enable or disable the distribution of an image captured by the camera 26 (see FIG. 7) to other participants. In the case of FIG. 12, “Camera is off” is displayed. However, in the present exemplary embodiment, even if the camera is set to OFF in the camera setting fields 251B and 252B, the capturing of an image by the camera 26 is not turned off, and the captured image is uploaded to the server 10.

In microphone setting fields 251C and 252C, it is possible to enable or disable the distribution of sound picked up by the microphone 27 to other participants. On the settings screen 251, a switch 251C1 used to toggle the microphone on/off is in the ON position. Accordingly, a slider 251C2 used to adjust the volume is displayed in an operable state. The adjustment of volume here corresponds to the adjustment of the microphone sensitivity.

On the settings screen 252, a switch 252C1 used to toggle the microphone 27 on/off is in the OFF position. Accordingly, a slider 252C2 used to adjust the volume is displayed in a non-operable state. In addition, a “volume input” mode setting button 252C3 is displayed to the right of the slider 252C2. In the case of FIG. 12, the setting button 252C3 is labeled “Volume Mode”. Also, the setting button 252C3 is set to ON. If the “volume input” mode is set to ON, volume information Y expressing the volume of sound picked up by the built-in or connected microphone 27 is transmitted to the server 10 (see FIG. 1). As described above, in the present exemplary embodiment, the uploading of volume information Y to the server 10 is limited to the case where the volume is equal to or greater than the reference value REF.

Incidentally, if the “volume input” mode is set to OFF, the uploading of volume information Y to the server 10 is also stopped. “Cancel” buttons 251D and 252D and “Join Now” buttons 251E and 252E are placed in the lower portion of the settings screens 251 and 252. If the “Cancel” button 251D, 252D is operated, the setting in the camera setting field 251B, 252B and the setting in the microphone setting field 251C, 252C are canceled. If the “Join Now” button 251E, 252E is operated, the settings are applied and a notification of participation in the web conference is transmitted to the server 10.

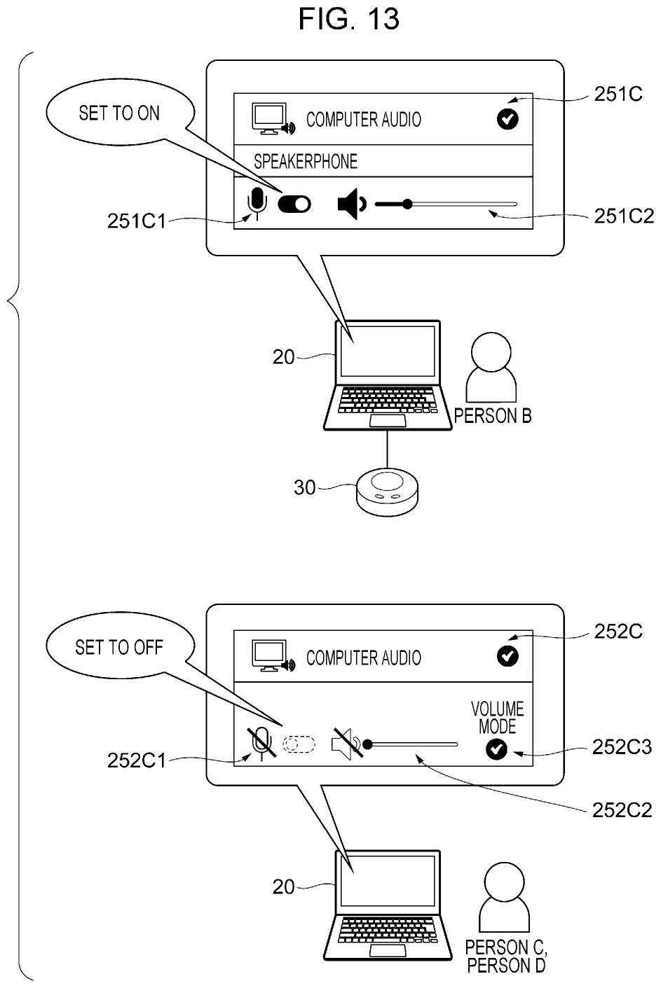

FIG. 13 is a diagram for explaining a settings screen for persons B, C, and D who gather together in a conference room to participate in the web conference. The speakerphone 30 is connected to the user terminal 20 of person B. Consequently, the user terminal 20 of person B streams a voice inputted from the speakerphone 30 to the server 10. For this reason, in the user terminal 20 of person B, the switch 251C1 of the microphone setting field 251C is set to ON. On the other hand, persons C and D upload their own voices to the server 10 through the speakerphone 30. For this reason, in the corresponding user terminals 20, the switch 252C1 of the microphone setting field 251C is set to OFF.

The description will now return to FIG. 11. In the case of the present exemplary embodiment, persons A and B set their user terminals 20 to the “voice input” mode and request participation (step 1). Also, persons C and D set their user terminals 20 to the “volume input” mode and request participation (step 2). The server 10 receiving the requests initiates connections with the corresponding user terminals 20 (step 3). Next, the server 10 streams a shared screen including information about the participants to all participants (step 4).

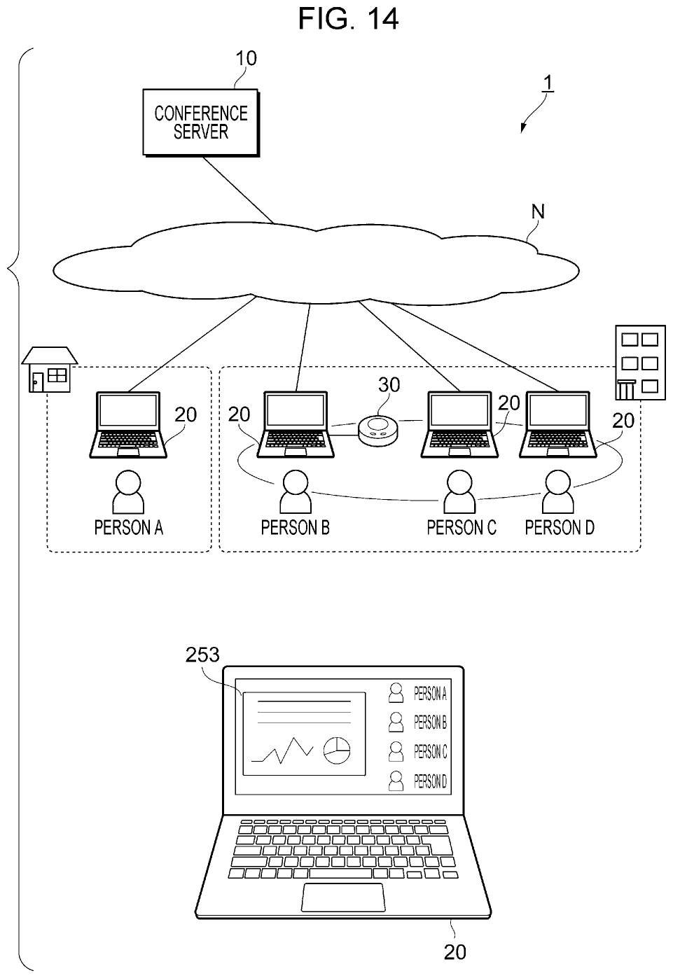

FIG. 14 is a diagram for explaining an exemplary display of a shared screen 253 at the stage of accepting participants. In FIG. 14, portions that correspond to FIG. 1 are denoted with corresponding signs. On the shared screen 253 illustrated in FIG. 14, participation by persons A, B, C, and D is confirmed. On the shared screen 253, an indication of whether persons are participating as a group is not displayed. The description will now return to FIG. 11. Next, the server 10 acquires the microphone mode of each user (step 5). In this example, the microphone mode is the “voice input” mode for persons A and B, while the microphone mode is the “volume input” mode for persons C and D.

Furthermore, the server 10 identifies groups that users participate in (step 6). To identify groups, the IP addresses or the like of the user terminals 20 are used, for example. In the present exemplary embodiment, persons B, C, and D are identified as belonging to the same group. Identifying a group makes it possible to identify the speaking person belonging to the group. If person A or someone in the group speaks, a user terminal 20 in the “voice input” mode acquires voice information X (step 7) and uploads the acquired voice information X to the server 10 (step 8). For instance, if person C speaks, the user terminal 20 of person B uploads voice information X to the server 10. Note that if person A or person B speaks, steps 9 to 11 described later are not executed.

If person C or D in the group speaks, the corresponding user terminal 20 acquires the volume (step 9). Next, the corresponding user terminal 20 determines whether the acquired volume is greater than the reference value REF (step 10). If the volume is less than or equal to the reference value REF, there is a high probability that the sound is not speech, and therefore a negative result is obtained in step 9. In this case, the user terminal 20 returns to step 9. On the other hand, if the volume is greater than the reference value REF, a positive result is obtained in step 10. In this case, the user terminal 20 uploads volume information Y to the server 10 (step 11).

The server 10 receives voice information X, or voice information X and volume information Y (step 12). Incidentally, the upload source of voice information X is limited to the user terminal 20 corresponding to person A or B, and the upload source of volume information Y is limited to the user terminal 20 corresponding to person C or D. If person A or B is the speaking person, the server 10 receives only voice information X. On the other hand, if person C or D is the speaking person, the server 10 receives volume information Y in addition to voice information X. In either case, the server 10 distributes the received voice information X to user terminals 20 operating in the “voice input” mode (step 13). Through the distribution, the sharing of the voices of other users with all users is achieved.

Next, the server 10 determines whether volume information Y is received (step 14). In other words, it is determined whether voice information X and volume information Y are received at the same time. If only voice information X is received and volume information Y is not received, a negative result is obtained in step 14. In this case, the server 10 identifies the user of the user terminal 20 that transmitted the voice information X as the speaking person (step 15). In contrast, if volume information Y is received, a positive result is obtained in step 14. In this case, the server 10 identifies the user corresponding to the maximum value of the volume information Y (step 16). This process is provided to enable identification of the speaking person even if volume information Y is uploaded from multiple sources. Next, the server 10 identifies the identified user as the speaking person (step 17).

If the speaking person is identified in step 15 or 17, the server 10 updates the display of the speaking person on the shared screen and streams the updated shared screen to all participants (step 18). The user terminals 20 corresponding to persons A, B, C, and D display the streamed shared screen (step 19). Note that the server 10 records a dialogue history linking the voice information with the speaking person (step 20). Thereafter, steps 7 to 20 are repeated until the web conference ends.

### Example of Identifying Speaking Person

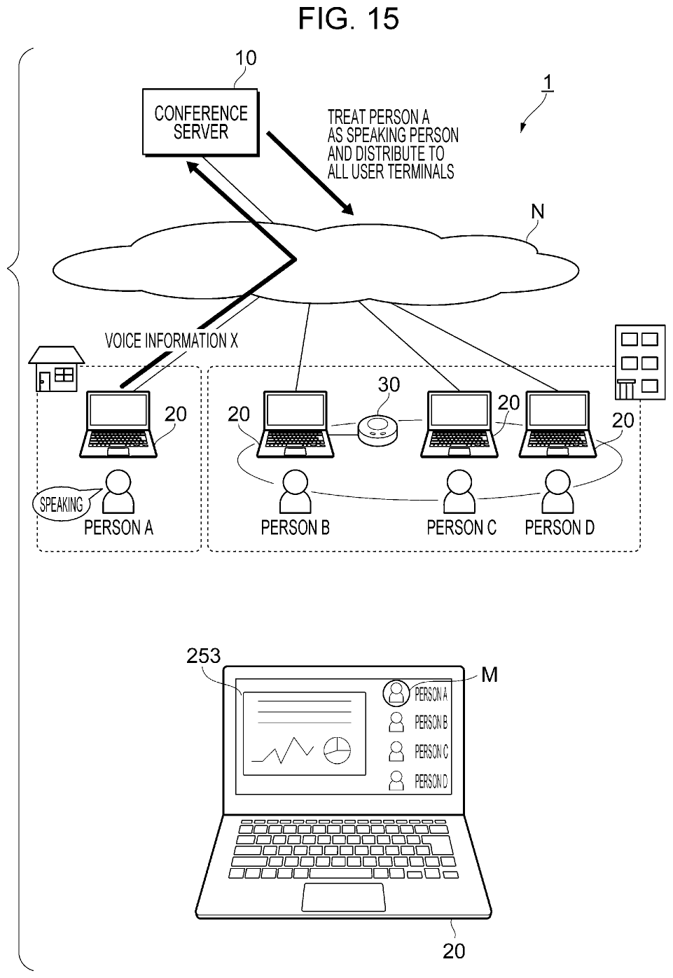

Hereinafter, FIGS. 15 to 18 will be used to describe a specific example of a process of identifying a user who speaks, that is, the speaking person, in a web conference. FIG. 15 is a diagram for explaining a case where person A not belonging to the group speaks. In FIG. 15, portions that correspond to FIG. 1 are denoted with corresponding signs. Person A does not belong to the group and therefore sets their user terminal 20 to the “voice input” mode. Accordingly, voice information X is uploaded from the user terminal 20 of person A to the server 10. At this time, the server 10 receives only voice information X and therefore obtains a negative result in step 14 (see FIG. 11) and identifies person A who uploaded the voice information X as the speaking person. For this reason, the server 10 streams to all user terminals 20 with person A treated as the speaking person. Consequently, on the shared screen 253 of each user terminal 20, a mark M indicating the speaking person is displayed at the position of person A.

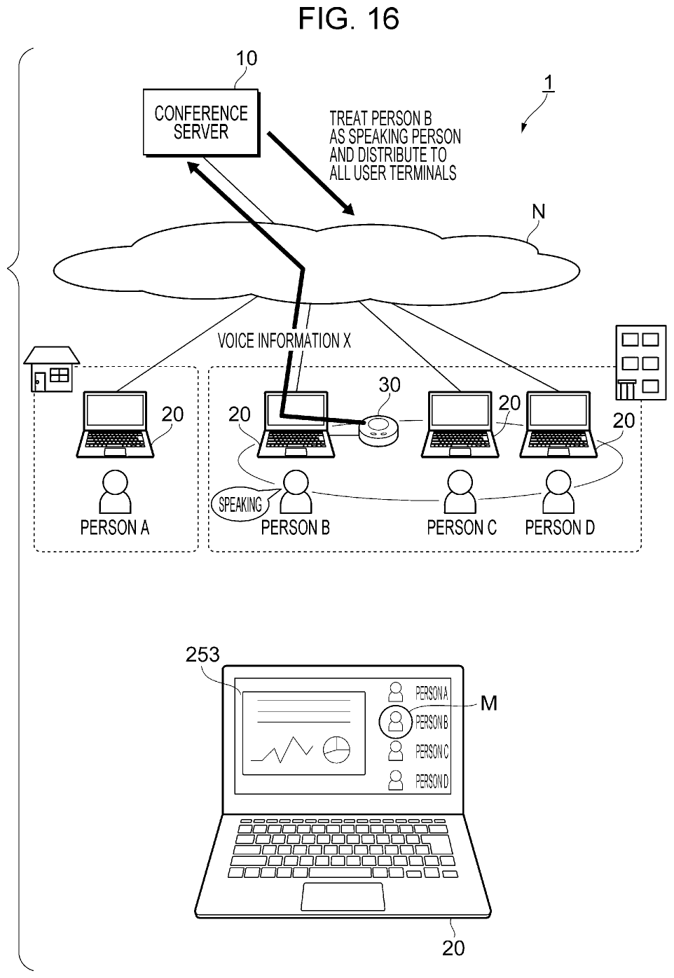

FIG. 16 is a diagram for explaining a case where person B belonging to the group speaks. In FIG. 16, portions that correspond to FIG. 1 likewise are denoted with corresponding signs. Person B belongs to the group, but the speakerphone 30 is connected to their own user terminal 20. Consequently, the user terminal 20 of person B is set to the “voice input” mode. Accordingly, voice information X is uploaded from the user terminal 20 of person B to the server 10. At this time, the server 10 receives only voice information X and therefore obtains a negative result in step 14 (see FIG. 11) and identifies person B who uploaded the voice information X as the speaking person. For this reason, the server 10 streams to all user terminals 20 with person B treated as the speaking person. Consequently, on the shared screen 253 of each user terminal 20, a mark M indicating the speaking person is displayed at the position of person B.

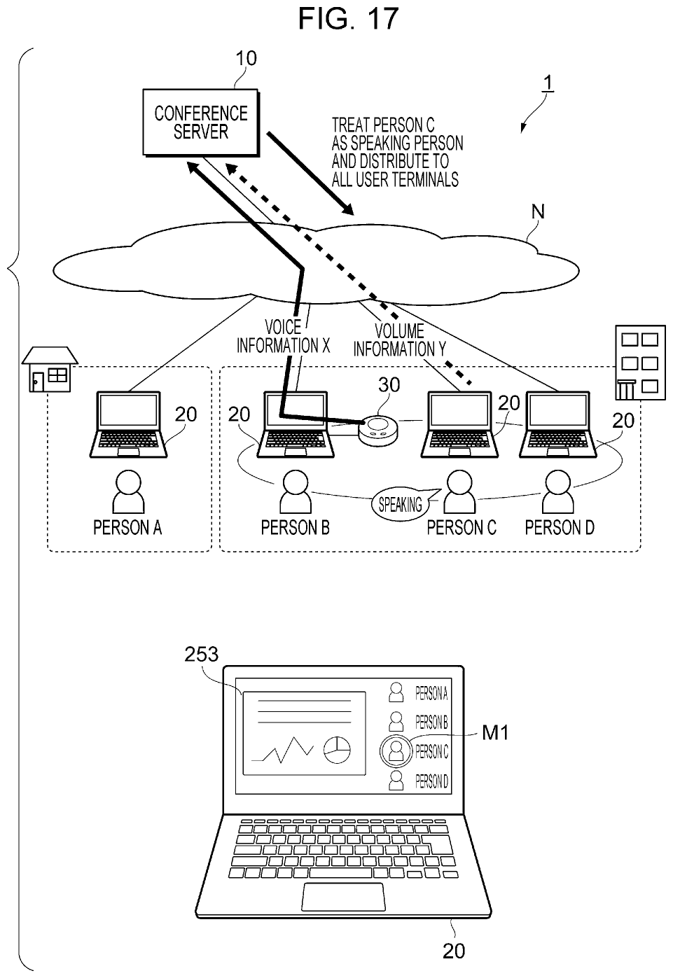

FIG. 17 is a diagram for explaining a case where person C belonging to the group speaks. In FIG. 17, portions that correspond to FIG. 15 likewise are denoted with corresponding signs. Person C belongs to the group, and the speakerphone 30 is not connected to their own user terminal 20. Consequently, the user terminal 20 of person C is set to the “volume input” mode. Accordingly, volume information Y is uploaded from the user terminal 20 of person C to the server 10. Note that voice information X corresponding to the voice of person C is uploaded from the speakerphone 30 to the server 10 via the user terminal 20 of person B.

In this case, the server 10 receives both voice information X and volume information Y, and therefore obtains a positive result in step 14 (see FIG. 11). In the case of FIG. 17, the user terminal 20 that uploads volume information Y is linked to person C. Accordingly, the server 10 identifies person C who uploaded the volume information Y as the speaking person. For this reason, the server 10 streams to all user terminals 20 with person C treated as the speaking person. Consequently, on the shared screen 253 of each user terminal 20, a mark M1 indicating the speaking person is displayed at the position of person C. Note that the mark M1 is different from the cases where persons A and B are the speaking person. The reason is to indicate that volume information Y was used to identify the speaking person. However, it is also possible to use display person C as the speaking person using the same mark M as the cases where person A and B are the speaking person.

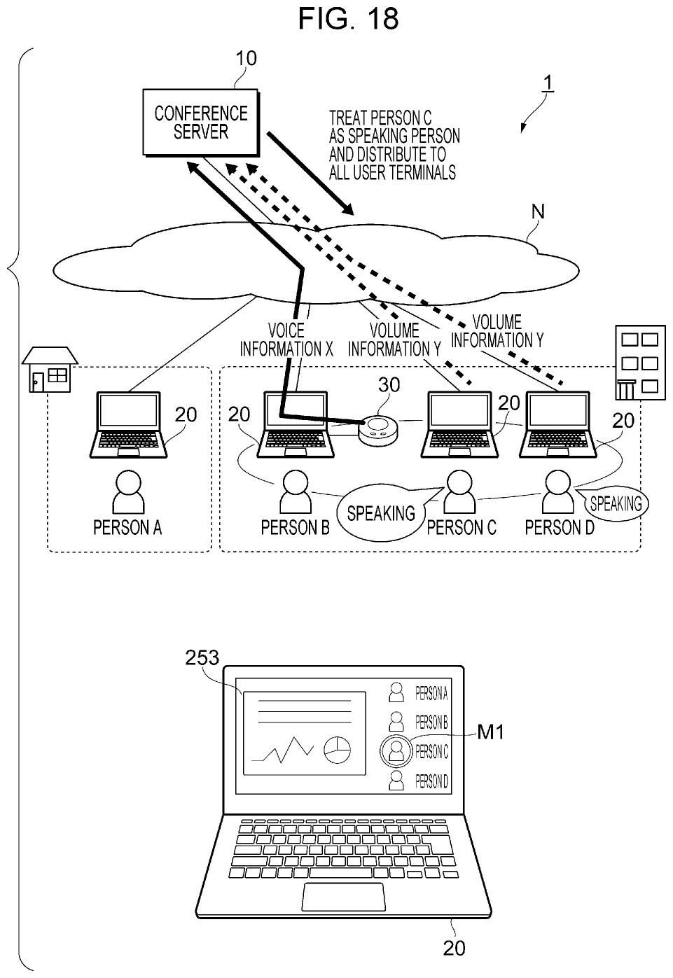

FIG. 18 is a diagram for explaining a case where persons C and D belonging to the group speak at the same time. In FIG. 18, portions that correspond to FIG. 15 likewise are denoted with corresponding signs. Persons C and D belong to the same group, and the speakerphone 30 is not connected to their own user terminals 20. Consequently, the user terminals 20 of persons C and D are both set to the “volume input” mode. Accordingly, volume information Y is uploaded to the server 10 from both the user terminal 20 of person C and the user terminal 20 of person D. Note that voice information X corresponding to the voices of persons C and D is uploaded from the speakerphone 30 to the server 10 via the user terminal 20 of person B.

In this case, the server 10 receives both voice information X and volume information Y, and therefore obtains a positive result in step 14 (see FIG. 11). However, in the case of FIG. 18, the voice of person C is louder than the voice of person D. In FIG. 18, the loudness of each voice is represented by the size of the speech balloon. In the case of FIG. 18, the user terminals 20 that upload volume information Y are linked to persons C and D, respectively. However, the numerical value of the volume information Y inputted from the user terminal 20 corresponding to person C is greater. Accordingly, the server 10 identifies person C who uploaded the volume information Y as the speaking person. For this reason, the server 10 streams to all user terminals 20 with person C treated as the speaking person. Consequently, on the shared screen 253 of each user terminal 20, a mark M1 indicating the speaking person is displayed at the position of person C.

<Other Identification Process 1>

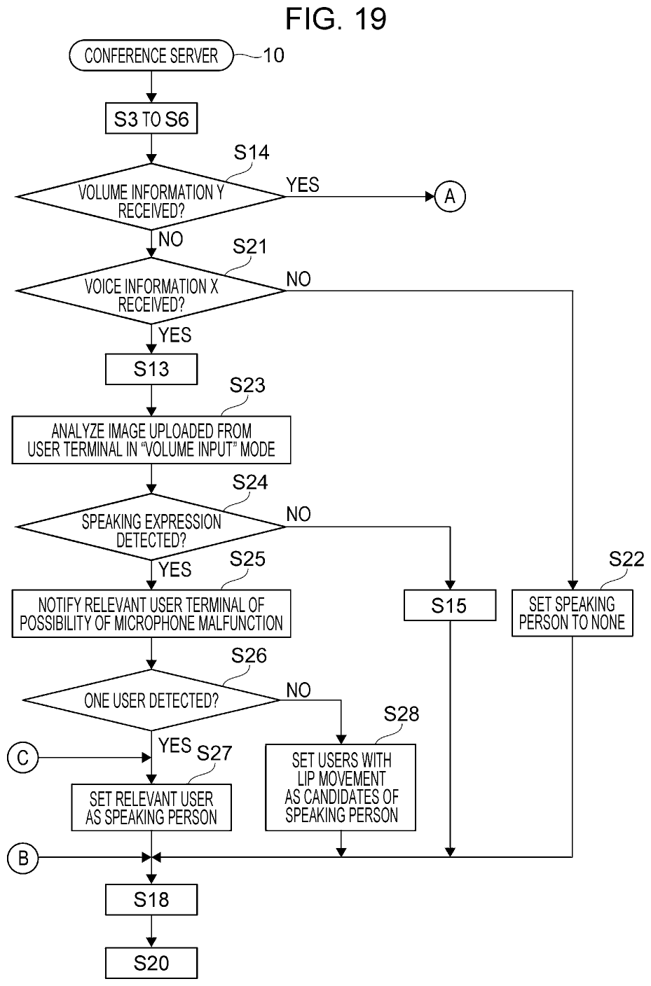

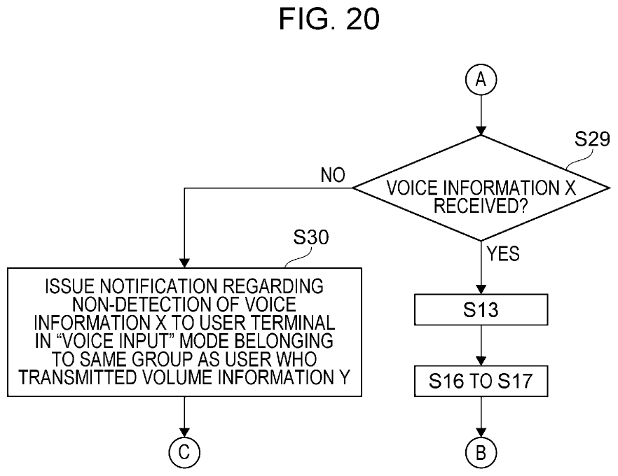

At this point, the identification or inference of the speaking person in a situation in which voice information X and volume information Y do not arrive at the server 10 (see FIG. 1) normally will be described. FIG. 19 is a diagram for explaining one portion of other processing operations executed by the server 10. FIG. 20 is a diagram for explaining a remaining portion of other processing operations executed by the server 10. Note that in FIGS. 19 and 20, portions that correspond to FIG. 11 are denoted with corresponding signs. Also, a duplicate description is omitted for processing operations shared with FIG. 11.

In the case of FIG. 19, the server 10 executes step 14 after executing steps 3 to 6. That is, the server 10 does not execute steps 12 and 13. If a negative result is obtained in step 14, the server 10 determines whether voice information X is received (step 21). If a negative result is obtained in step 21, that is, if neither voice information X nor volume information Y is received, the server 10 sets the speaking person to none (step 22) and executes steps 18 and 20 in that order. Specifically, the display of the speaking person on the shared screen is updated and distributed to all participants, and a dialogue history linking the voice information X and the speaking person is recorded.

In contrast, if a positive result is obtained in step 21 (that is, if voice information X is received but volume information Y is not received), the server 10 executes step 13. That is, the received voice information X is distributed to user terminals 20 operating in the “voice input” mode. Next, the server 10 analyses an image uploaded from a user terminal 20 in the “volume input” mode (step 23). Next, the server 10 determines whether a speaking expression is detected (step 24). If a speaking expression is not detected, the server 10 obtains a negative result in step 24. In this case, the server 10 executes steps 15, 18, and 20 in that order.

On the other hand, if a speaking expression is detected, the server 10 obtains a positive result in step 24. In this case, the server 10 notifies the relevant user terminal 20 of the possibility of a microphone malfunction (step 25). Additionally, the server 10 determines whether the detected user is a single person (step 26). If there is a single person, a positive result is obtained in step 26. In this case, the server 10 identifies the relevant user as the speaking person (step 27). If there are multiple persons, a negative result is obtained in step 26. In this case, the server 10 sets multiple users with lip movement as candidates of the speaking person (step 28). This is because in the current situation, volume information Y is not received from any of the user terminals 20 in the same group, and the speaking person could not be identified as a single user due to volume differences.

Otherwise, if a positive result is obtained in step 14 (that is, if volume information Y is received), the server 10 determines whether voice information X is received (step 29). If a positive result is obtained in step 29 (that is, if both voice information X and volume information Y are received), the server 10 executes steps 13, 16, and 17 in that order, and then proceeds to step 18. On the other hand, if a negative result is obtained in step 29 (that is, if volume information Y is received but voice information X is not received), the server 10 issues a notification regarding non-detection of voice information X to the user terminal 20 in the “voice input” mode belonging to the same group as the user who transmitted the volume information Y (step 30).

There are various reasons why voice information X would not be received, including the case where the speakerphone 30 (see FIG. 1) is powered off, the case where communication trouble occurs between the speakerphone 30 and the user terminal 20, and the case where the user who is the speaking person is too far away from the speakerphone 30, for example. After issuing the notification, the server 10 proceeds to step 27 and identifies the speaking person or candidates of the speaking person. Hereinafter, specific examples will be described using the drawings.

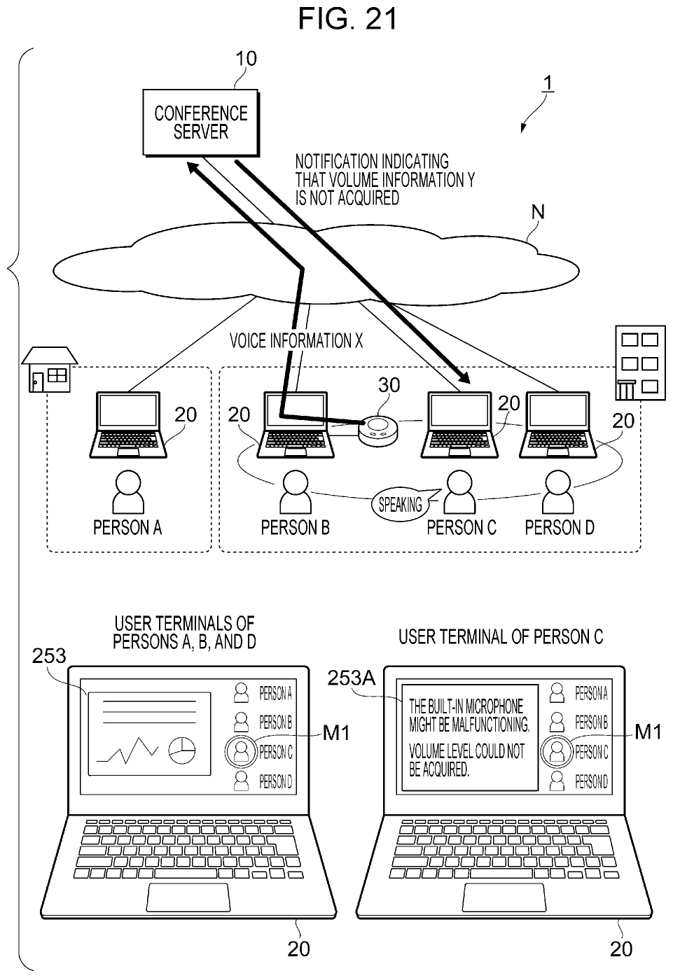

FIG. 21 is a diagram for explaining another example of a case where person C belonging to the group speaks. In FIG. 21, portions that correspond to FIG. 17 are denoted with corresponding signs. In the case of FIG. 21, volume information Y is not uploaded from the user terminal 20 of person C to the server 10. However, an image captured by the camera 26 (see FIG. 7) is uploaded to the server 10 from the user terminal 20 of person C. In the case of FIG. 21, lip movement by person C is detected from an analysis of the uploaded image. As a result, the server 10 streams to all user terminals 20 with person C treated as the speaking person, while inferring that a microphone malfunction is the reason why volume information Y is not uploaded.

Accordingly, on the user terminal 20 of person C, mark M1 indicating the speaking person is displayed at the position of person C and a warning message 253A is displayed on the shared screen 253. In the case of FIG. 21, “The built-in microphone might be malfunctioning.” and “Volume level could not be acquired.” are displayed as the warning message 253A. Note that in the case of FIG. 21, on the user terminals 20 of persons A, B, and D, only the mark M1 indicating the speaking person is displayed at the position of person C on the shared screen 253. However, the inexpedience of the user terminal 20 corresponding to person C may also be displayed to persons B and D belonging to the group.

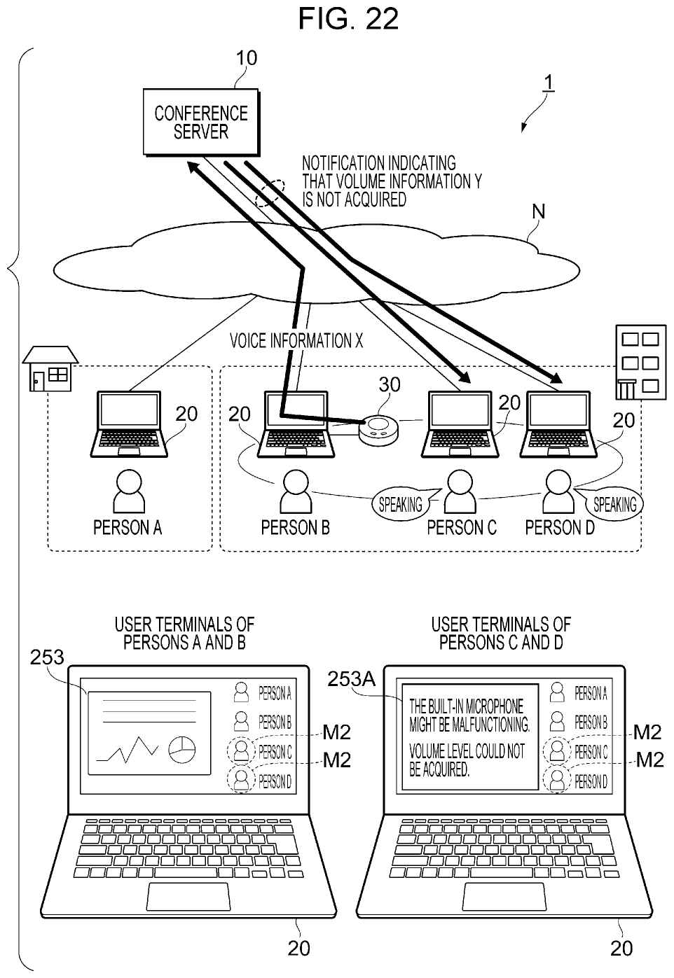

FIG. 22 is a diagram for explaining another example of a case where persons C and D belonging to the group speak at the same time. In FIG. 22, portions that correspond to FIG. 21 are denoted with corresponding signs. In FIG. 22, volume information Y is not uploaded to the server 10 from either of the user terminals 20 of persons C and D, both of whom are the speaking person. However, an image captured by the camera 26 (see FIG. 7) is uploaded to the server 10 from each of the user terminal 20 of person C and the user terminal 20 of person D. In the case of FIG. 22, lip movement by both persons C and D is detected from an analysis of the uploaded images.

In this case, the server 10 does not know the difference in volume between the speech of person C and the speech of person D. Consequently, the speaking person is not identified as a single person. Thus, on the shared screen 253 of the user terminals 20 of persons A, B, C, and D, a mark M2 indicating the speaking person is displayed at the position of each of persons C and D. The mark M2 herein has a different display appearance than the mark M1 indicating that a user within the group is the speaking person. This is because although there is certainly the possibility of a speaking person, the confidence is lower compared to the case where the speaking person is identified as a single person. Note that the difference in the display appearance may be achieved with color, brightness, or the shape of a symbol. Note that in this case, too, the warning message 253A is displayed on the user terminals 20 corresponding to persons C and D.

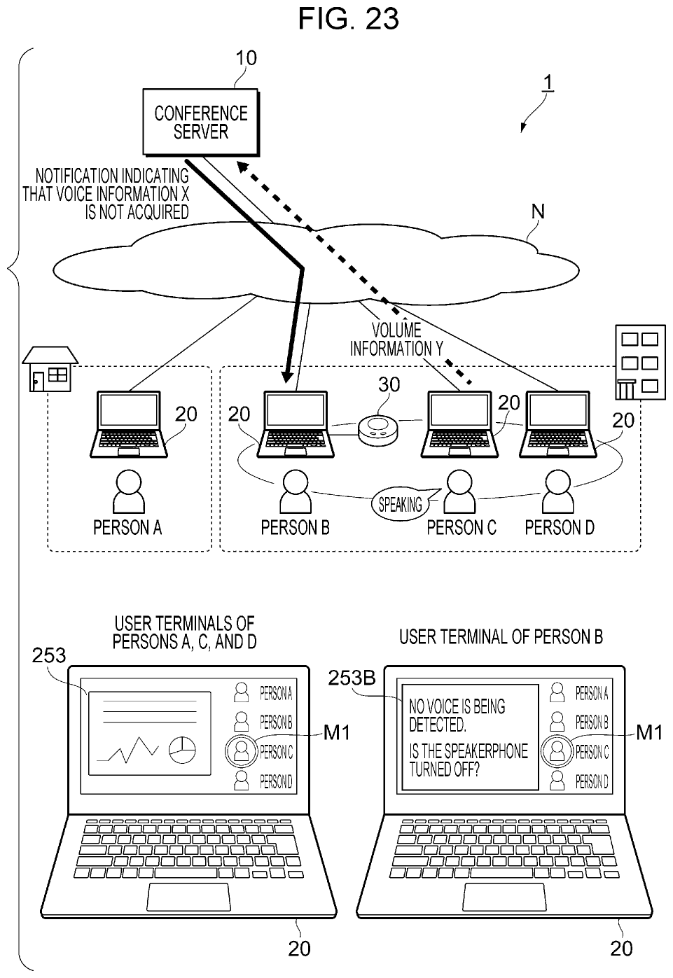

FIG. 23 is a diagram for explaining an example in which person C belonging to the group speaks, but voice information X pertaining to person C is not received by the server 10. In FIG. 23, portions that correspond to FIG. 17 are denoted with corresponding signs. In the case of FIG. 23, volume information Y is uploaded to the server 10 from the user terminal 20 of person C, who is the speaking person. However, voice information X pertaining to person C is not uploaded to the server 10 from the user terminal 20 of person B who belongs to the same group as person C. In this case, too, volume information Y from persons other than person C in the same group as person C is not received, and therefore the server 10 identifies the speaking person as person C.

However, in the state in which voice information X pertaining to person C is not being received successfully, the web conference is not established. Accordingly, the server 10 issues a notification indicating that voice information X is not being received to the user terminal 20 connected to the speakerphone 30. Thus, a warning message 253B is displayed on the shared screen 253 on the user terminal 20 of person B. In the case of FIG. 23, “No voice is being detected.” and “Is the speakerphone turned off?” are displayed as the warning message 253B. Note that the speakerphone 30 being powered off is merely one possible reason why voice information X may not be uploaded successfully. Accordingly, other possibilities may be displayed in sequence or all at once.

<Other Identification Process 2>

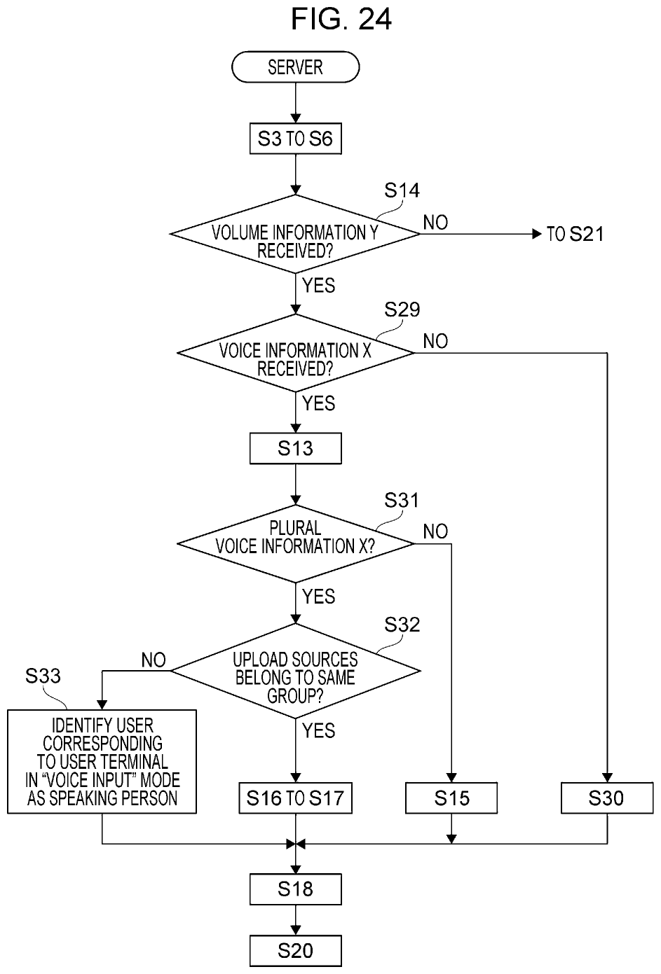

At this point, identification of the speaking person in the case where voice information X is uploaded from multiple user terminals 20 at the same time will be described. FIG. 24 is a diagram for explaining an example of other processing operations executed by the server 10. Note that in FIG. 24, portions that correspond to FIGS. 11, 19, and 20 are denoted with corresponding signs. Also, a duplicate description is omitted for processing operations shared with FIG. 11.

In the case of FIG. 24, the server 10 executes step 14 after executing steps 3 to 6. That is, the server 10 does not execute steps 12 and 13. If a negative result is obtained in step 14 (that is, if volume information Y is not received), the server 10 proceeds to step 21. The processing operations from step 21 are the same as in FIG. 19. If a positive result is obtained in step 14 (that is, if volume information Y is received), the server 10 determines whether voice information X is received (step 29). If a negative result is obtained in step 29 (that is, if volume information Y is received but voice information X is not received), the server 10 proceeds to step 30 and issues a notification regarding non-detection of voice information X to the user terminal 20 in question.

If a positive result is obtained in step 29, the server 10 executes step 13. That is, the received voice information X is distributed to user terminals operating in the “voice input” mode. Next, the server 10 determines whether the voice information X is plural (step 31). If a negative result is obtained in step 31 (the case where the voice information X is singular), the server 10 executes steps 18 and 20 in that order. If a positive result is obtained in step 31 (the case where the voice information X is plural), the server 10 determines whether the upload sources belong to the same group (step 32).

If a positive result is obtained in step 32 (the case where plural voice information X is uploaded from the same group), the server 10 executes steps 16, 17, 18, and 20 in that order. If a negative result is obtained in step 32 (the case where plural voice information X is not uploaded from the same group), the server 10 identifies the user corresponding to the user terminal 20 in the “voice input” mode as the speaking person (step 33). Thereafter, the server 10 executes steps 18 and 20 in that order.

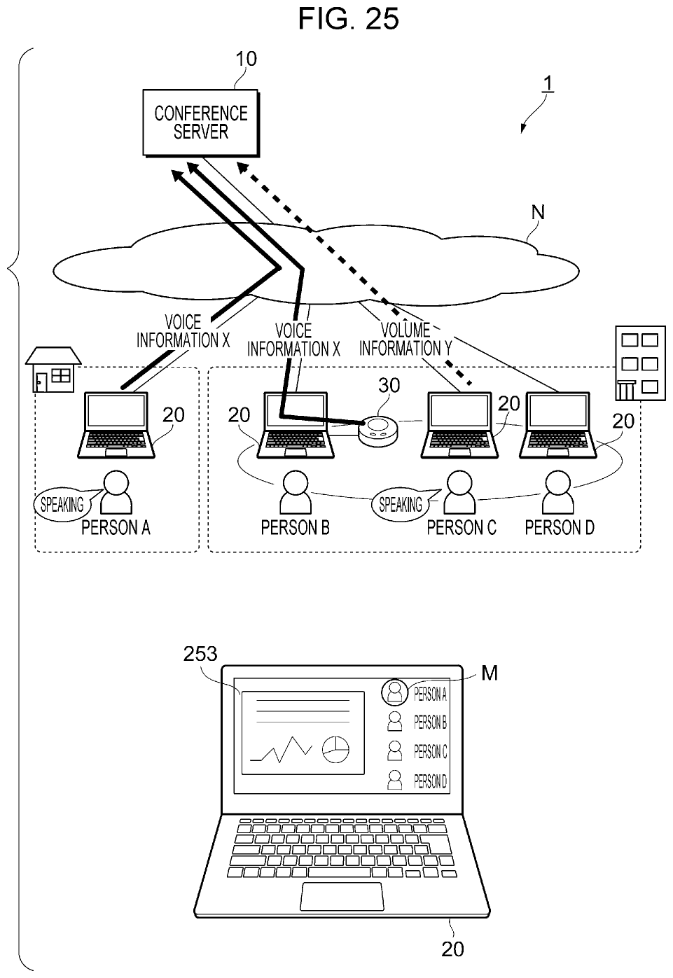

FIG. 25 is a diagram for explaining an example of identifying the speaking person from between two users who do not belong to the same group. In FIG. 25, portions that correspond to FIG. 15 are denoted with corresponding signs. In the case of FIG. 25, persons A and C are speaking at the same time. However, person C belongs to the group, whereas person A does not belong. In this case, the server 10 receives voice information X from the user terminal 20 of person A. Also, voice information X is received from the user terminal 20 of person B, and volume information Y is received from the user terminal 20 of person C. Since persons B and C belong to the same group, person C is identified as the person who spoke within the group. However, in step 33 described with reference to FIG. 24, person A is identified as the speaking person. Accordingly, the mark M is displayed at the position of person A on the shared screen 253.

### Other Exemplary Embodiments

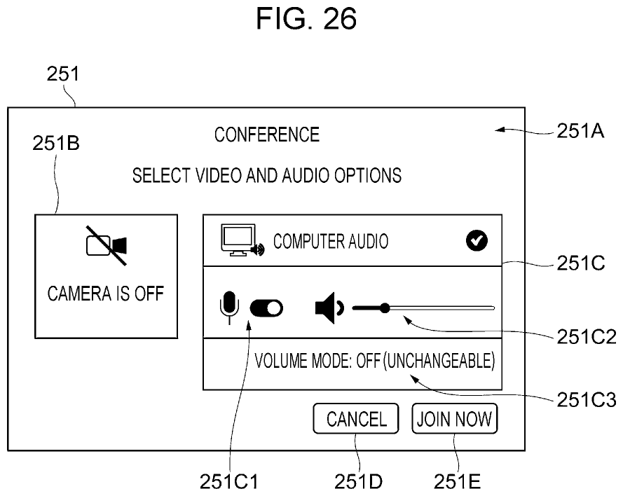

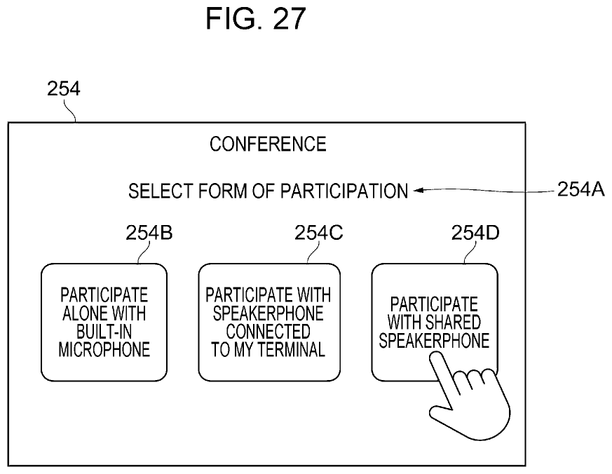

(1) The foregoing describes an exemplary embodiment of the present disclosure, but the technical scope of the present disclosure is not limited to the scope described in the foregoing exemplary embodiment. It is clear from the claims that a variety of modifications or alterations to the foregoing exemplary embodiment are also included in the technical scope of the present disclosure.
(2) The exemplary embodiment described above indicates that the uploading of volume information to the server 10 is limited to the case where a user terminal 20 operating in the “volume input” mode detects a volume equal to or greater than a reference value, but the server 10 may also make the determination of whether the level of sound is equal to or greater than the reference value. In this case, the user terminal 20 operating in the “volume input” mode continually uploads volume information expressing the level of sound picked up by the built-in microphone or the like to the server 10.
(3) The exemplary embodiment described above indicates an example in which video and audio settings for the web conference are received through a browser screen, but video and audio settings for the web conference may also be received through a setup screen provided by a program executed on the user terminal 20.
(4) In the exemplary embodiment described above, the volume mode setting button 252C3 (see FIG. 12) is displayed in the microphone setting field 252C only if the microphone 27 (see FIG. 7) is set to OFF, but may also be displayed in the microphone setting field 251C even if the microphone is set to ON. FIG. 26 is a diagram for explaining an example of a settings screen. In FIG. 26, portions that correspond to FIG. 12 are denoted with corresponding signs. In the case of the settings screen 251 illustrated in FIG. 26, the microphone 27 is set to ON. Accordingly, the switch 251C1 is in the ON position, and the slider 251C2 on the right is in an operable state. However, a volume mode display field 251C3 is added to the lower portion of the settings screen 251 illustrated in FIG. 26. Since the volume mode is only active when the microphone 27 is off, “OFF (unchangeable) is displayed in the display field 251C3 in FIG. 26.
(5) In the exemplary embodiment described above, the input mode is determined according to the setting of the microphone 27 (see FIG. 7) on the settings screens 251 and 252 (FIG. 12), but the input mode may also be determined according to the selection of a form of participation in the web conference by the user. FIG. 27 is a diagram for explaining an exemplary screen used to accept a form of participation in a web conference. On a reception screen 254, an explanation 254A and three selection buttons 254B, 254C, and 254D are provided. In the case of FIG. 27, a phrase prompting for selection, such as “Select form of participation”, is presented in the explanation 254A.

The selection button 254B is labeled “Participate alone with built-in microphone”. The selection button 254B anticipates a case where the user participates in the web conference in an environment where other users are not present, like person A in FIG. 1, or the case where other users are present in the same room but voice information X is to be uploaded to the server 10 without using the speakerphone 30. The selection button 254C is labeled “Participate with speakerphone connected to my terminal”. The selection button 254C anticipates participation as person B in FIG. 1. The selection button 254D is labeled “Participate with shared speakerphone”. The selection button 254D anticipates a user for whom the speakerphone 30 is not connected to their own terminal, like persons C and D in FIG. 1.

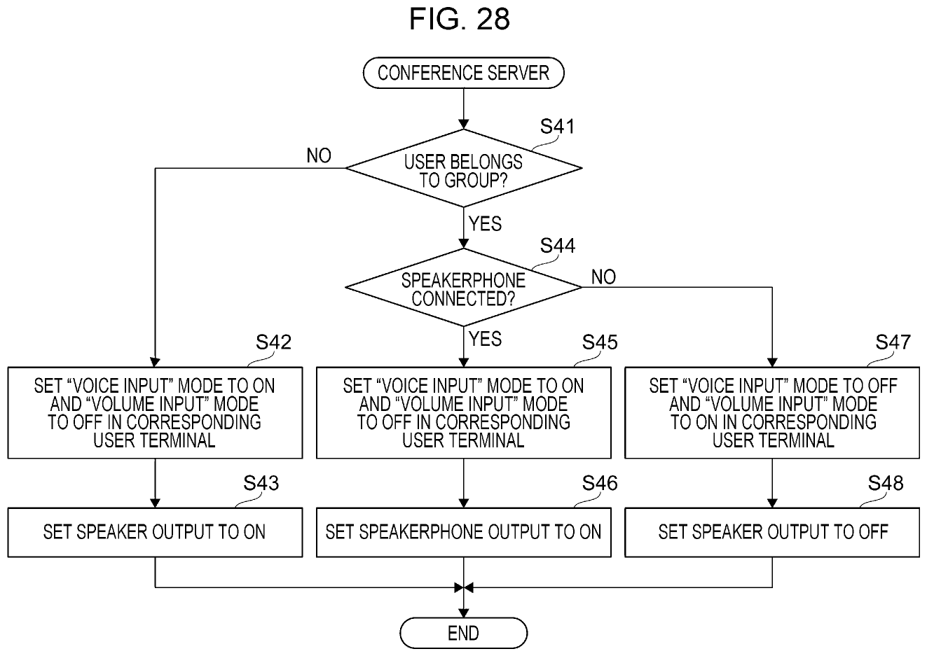

FIG. 28 is a flowchart for explaining an example of remote control by the server 10 in the case where a user operation is accepted on the reception screen 254. First, the server 10 determines whether the user belongs to a group (step 41). For example, if the user operates the selection button 254B (see FIG. 27), the server 10 obtains a negative result in step 41. In this case, the server 10 sets the “voice input” mode to ON and the “volume input” mode to OFF for the corresponding user terminal 20 (step 42). Thereafter, the server 10 sets the output of the speaker 28 (see FIG. 7) to ON (step 43). With this arrangement, the input of the voice of the corresponding user and the output of the voices of other users are executed on the user terminal 20.

In contrast, if the user operates the selection button 254C (see FIG. 27) or 254D (see FIG. 27), the server 10 determines whether the speakerphone 30 is connected (step 44). In the case of a user to which the speakerphone 30 is connected (the case of a user who operates the selection button 254C), the server 10 obtains a positive result in step 44. In this case, the server 10 sets the “voice input” mode to ON and the “volume input” mode to OFF for the corresponding user terminal (step 45). Thereafter, the server 10 sets the output of the speakerphone 30 to ON (step 46).

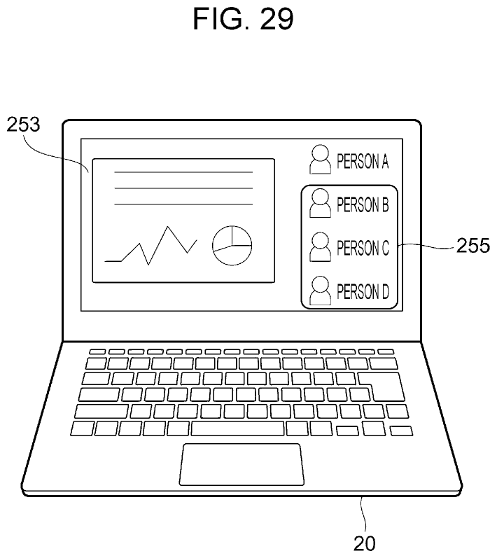

In the case of a user to which the speakerphone 30 is not connected (the case of a user who operates the selection button 254D), the server 10 obtains a negative result in step 44. In this case, the server 10 sets the “voice input” mode to OFF and the “volume input” mode to ON for the corresponding user terminal (step 47). Thereafter, the server 10 sets the output of the speaker 28 to OFF (step 48). This remote control is a function for assisting the user with setting up the user terminal 20, and reduces incorrect settings. As a result, the accuracy of speaking person identification is obviously improved, and howling is also reduced.
(6) In the exemplary embodiment described above, a list of the names of users participating in the web conference is displayed on the shared screen 253 (see FIG. 14), but the form of participation by each user is not displayed. That is, an indication of which users belong to the same group and which user does not belong to the group is not displayed on the shared screen 253. FIG. 29 is a diagram for explaining an exemplary display of the form of participation. In FIG. 29, portions that correspond to FIG. 14 are denoted with corresponding signs. On the shared screen 253 illustrated in FIG. 29, in addition to a list of persons A, B, C, and D participating in the web conference, persons B, C, and D belonging to the same group are displayed enclosed within a single frame 255. The display of the frame 255 indicates that person A does not belong to the group. The shared screen 253 illustrated in FIG. 29 is an example of displaying information about a participant belonging to a group with a different appearance from another participant not belonging to the group.

Note that a display appearance different from the frame 255 may also be adopted. For example, the background colors of persons B, C, and D may be set to a shared color that is different from the background color of person A. In another example, the display color of persons B, C, and D may be set to a shared color that is different from the display color of person A. In another example, an icon of the speakerphone 30, a symbol, a mark, or the like may be displayed beside the positions of persons B, C, and D only. In another example, the display appearance of persons B, C, and D may be differentiated from the display appearance of person A. In addition, differences in the form of participation within the group may also be expressed. For example, the display appearance may be differentiated between person B for whom the speakerphone 30 is connected to their own terminal, and persons C and D for whom the speakerphone 30 is not connected to their own terminals.

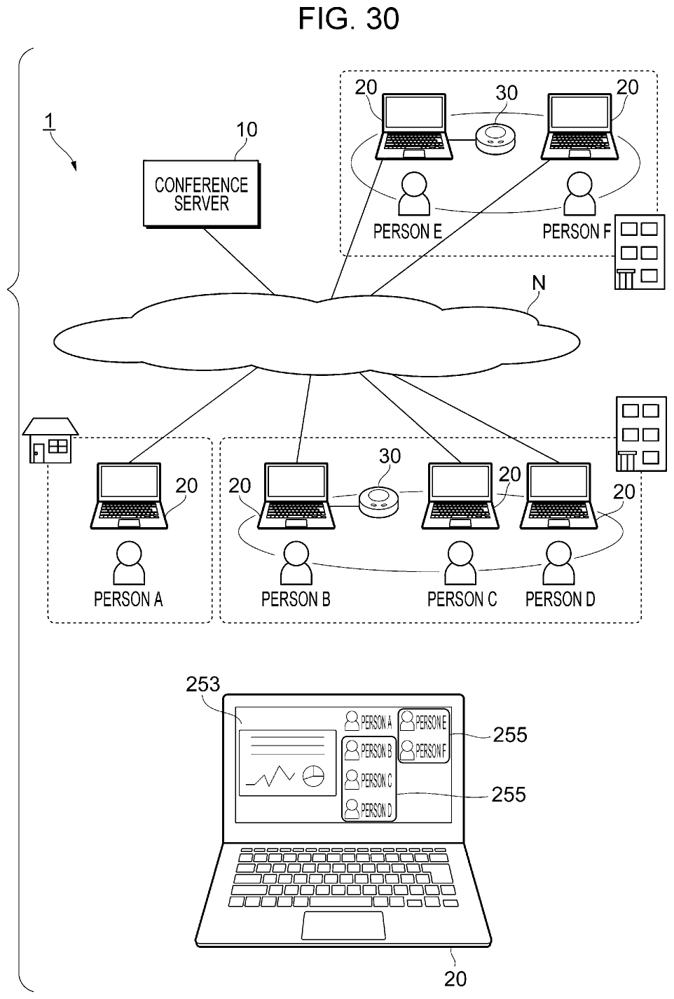

FIG. 30 is a diagram for explaining an exemplary display of the shared screen 253 in a case where the participants in a web conference are included in multiple groups. In FIG. 30, portions that correspond to FIGS. 1 and 29 are denoted with corresponding signs. In the case of FIG. 30, six persons A, B, C, D, E, and F participate in the web conference. Person A participates in the web conference alone, persons B, C, and D participate in the web conference in the form of a group together in a room, and persons E and F participate in the web conference in the form of a group together in a different room. Accordingly, two frames 255 are displayed on the shared screen 253 illustrated in FIG. 30. One frame 255 is placed around persons B, C, and D, and the other frame 255 is placed around persons E and F.
(7) In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A program causing a process to be executed by a computer operating as a server of a web conferencing system, the process including: identifying a group of participants sharing a microphone to be used for voice input; and identifying, if information indicating a volume equal to or greater than a reference value from a terminal not connected to the microphone from among terminals of the participants belonging to the group is inputted while a voice from the group is being inputted, the participant whose terminal corresponds to the transmission origin of the information as a speaking person.

(((2)))

The program according to (((1))), wherein the process further includes: displaying information about the participant corresponding to the terminal on a shared screen.

(((3)))

The program according to (((2))), wherein in the displaying, in a case where the participant identified as the speaking person belongs to the group, the information is displayed with a different appearance compared to case where the participant identified as the speaking person does not belong to the group.

(((4)))

The program according to any one of (((1))) to (((3))), wherein the process further includes: displaying information about a participant belonging to a group with a different appearance from another participant not belonging to the group.

(((5)))

The program according to (((4))), wherein if a plurality of groups are included, the displaying includes displaying differences between the groups.

(((6)))

The program according to any one of (((1))) to (((5))), wherein the process further includes: displaying, on a screen for initiating participation in a web conference, a button used to set transmission of information indicating volume.

(((7)))

The program according to (((6))), wherein the button is displayed if a voice input setting is set to OFF.

(((8)))

The program according to (((6))), wherein if a voice input setting is set to ON, the button is displayed in a non-operable state.

(((9)))

The program according to (((6))), wherein the button is displayed if a mode for sharing the microphone with another participant is selected.

(((10)))

The program according to any one of (((1))) to (((9))), wherein in the identifying of a group, a participant in whose terminal a setting for transmitting information indicating volume is enabled is linked to the group on a screen for initiating participation in a web conference.

(((11)))

The program according to (((10))), wherein in the identifying of a group, the group to which each participant belongs is identified on a basis of a location, on a network, of the terminal of the participant linked to the group.

(((12)))

The program according to any one of (((1))) to (((11))), wherein in the identifying of a participant as the speaking person, a participant whose terminal has transmitted information indicating a loudest volume within the same group is identified as the speaking person.

(((13)))

The program according to any one of (((1))) to (((12))), wherein in the identifying of a participant as the speaking person, if information indicating a volume equal to or greater than a reference value is not inputted from a terminal of a participant belong to a group while a voice from the group is being inputted, the participant linked to the terminal transmitting the voice is identified as the speaking person.

(((14)))

The program according to any one of (((1))) to (((13))), wherein in the identifying of a participant as the speaking person, if voice input from a participant not belonging to the group is detected, the participant is identified as the speaking person.

(((15)))

The program according to any one of (((1))) to (((14))), wherein the process further includes making a microphone sensitivity uniform among terminals of participants belonging to the same group.

(((16)))

The program according to any one of (((1))) to (((15))), wherein the process further includes issuing a notification if an input of information indicating a volume is detected from a terminal of a participant belonging to a group but an input of a voice from the same group is not detected, the notification indicating that the voice of a participant is not detected.

(((17)))

The program according to any one of (((1))) to (((16))), wherein the process further includes: transmitting an instruction to set a voice input to OFF and an instruction for setting information indicating a volume to ON to terminals other than the terminal in which the voice input is set to ON among the terminals of participants belonging to the group.

(((18)))

The program according to any one of (((1))) to (((17))), wherein the process further includes: recording information about the participant corresponding to the terminal in association with the voice.

(((19)))

A program causing a process to be executed by a computer operating as a terminal of a participant in a web conferencing system, the process including transmitting information indicating a volume to a server if a voice input is set to OFF.

(((20)))

The program according to (((19))), wherein the process further includes: processing an expression of the participant captured by a camera of the terminal, and detecting whether the participant is speaking; and transmitting information indicating speech to the server if the participant is detected to be speaking but information indicating a volume equal to or greater than a reference value is not detected.

(((21)))

The program according to (((20))), wherein in the detecting of whether the participant is speaking, a transmission of an image captured by the camera to the server is executed even if the transmission is set to OFF.

(((22)))

A web conferencing system including: a terminal of a participant in a web conference; and a server that establishes communication between terminals, wherein if a voice input is set to ON, the terminal transmits a voice to the server, whereas if the voice input is set to OFF, the terminal transmits information indicating a volume to the server, and if information indicating a volume equal to or greater than a reference value from a terminal not connected to a microphone to be used for voice input from among terminals of participants belonging to a group sharing the microphone is inputted while a voice from the group is being inputted, the server identifies the participant whose terminal corresponds to the transmission origin of the information as a speaking person.

What is claimed is:

1. A non-transitory computer readable medium storing a program causing a process to be executed by a computer operating as a server of a web conferencing system, the process comprising:
identifying a group of participants sharing a microphone to be used for voice input; and
identifying, if information indicating a volume equal to or greater than a reference value from a terminal not connected to the microphone from among terminals of the participants belonging to the group is inputted while a voice from the group is being inputted, the participant whose terminal corresponds to the transmission origin of the information as a speaking person.

2. The medium according to claim 1, storing a program causing the computer to execute a process further comprising:
displaying information about the participant corresponding to the terminal on a shared screen.

3. The medium according to claim 2, wherein in the displaying, in a case where the participant identified as the speaking person belongs to the group, the information is displayed with a different appearance compared to case where the participant identified as the speaking person does not belong to the group.

4. The medium according to claim 1, storing a program causing the computer to execute a process further comprising:
displaying information about a participant belonging to a group with a different appearance from another participant not belonging to the group.

5. The medium according to claim 4, wherein if a plurality of groups are included, the displaying includes displaying differences between the groups.

6. The medium according to claim 1, storing a program causing the computer to execute a process further comprising:
displaying, on a screen for initiating participation in a web conference, a button used to set transmission of information indicating volume.

7. The medium according to claim 6, wherein the button is displayed if a voice input setting is set to OFF.

8. The medium according to claim 6, wherein if a voice input setting is set to ON, the button is displayed in a non-operable state.

9. The medium according to claim 6, wherein the button is displayed if a mode for sharing the microphone with another participant is selected.

10. The medium according to claim 1, wherein in the identifying of a group, a participant in whose terminal a setting for transmitting information indicating volume is enabled is linked to the group on a screen for initiating participation in a web conference.

11. The medium according to claim 10, wherein in the identifying of a group, the group to which each participant belongs is identified on a basis of a location, on a network, of the terminal of the participant linked to the group.

12. The medium according to claim 1, wherein in the identifying of a participant as the speaking person, a participant whose terminal has transmitted information indicating a loudest volume within the same group is identified as the speaking person.

13. The medium according to claim 1, wherein in the identifying of a participant as the speaking person, if information indicating a volume equal to or greater than a reference value is not inputted from a terminal of a participant belong to a group while a voice from the group is being inputted, the participant linked to the terminal transmitting the voice is identified as the speaking person.

14. The medium according to claim 1, wherein in the identifying of a participant as the speaking person, if voice input from a participant not belonging to the group is detected, the participant is identified as the speaking person.

15. The medium according to claim 1, storing a program causing the computer to execute a process further comprising:
making a microphone sensitivity uniform among terminals of participants belonging to the same group.

16. The medium according to claim 1, storing a program causing the computer to execute a process further comprising:
issuing a notification if an input of information indicating a volume is detected from a terminal of a participant belonging to a group but an input of a voice from the same group is not detected, the notification indicating that the voice of a participant is not detected.

17. The medium according to claim 1, storing a program causing the computer to execute a process further comprising:
transmitting an instruction to set a voice input to OFF and an instruction for setting information indicating a volume to ON to terminals other than the terminal in which the voice input is set to ON among the terminals of participants belonging to the group.

18. The medium according to claim 1, storing a program causing the computer to execute a process further comprising:
recording information about the participant corresponding to the terminal in association with the voice.

19. A non-transitory computer readable medium storing a program causing a process to be executed by a computer operating as a terminal of a participant in a web conferencing system, the process comprising:
transmitting information indicating a volume to a server if a voice input is set to OFF.

20. The medium according to claim 19, storing a program causing the computer to execute a process further comprising:
processing an expression of the participant captured by a camera of the terminal, and detecting whether the participant is speaking; and
transmitting information indicating speech to the server if the participant is detected to be speaking but information indicating a volume equal to or greater than a reference value is not detected.

21. The medium according to claim 20, wherein in the detecting of whether the participant is speaking, a transmission of an image captured by the camera to the server is executed even if the transmission is set to OFF.

22. A web conferencing system comprising:
a terminal of a participant in a web conference; and a server that establishes communication between terminals, wherein
if a voice input is set to ON, the terminal transmits a voice to the server, whereas if the voice input is set to OFF, the terminal transmits information indicating a volume to the server, and
if information indicating a volume equal to or greater than a reference value from a terminal not connected to a microphone to be used for voice input from among terminals of participants belonging to a group sharing the microphone is inputted while a voice from the group is being inputted, the server identifies the participant whose terminal corresponds to the transmission origin of the information as a speaking person.
